(19) United States
(12) Patent Application Publication
(10) Pub. No.: US 2026/0360342 A1
(43) Pub. Date: Nov. 12, 2026

(54) SYSTEMS, METHODS, AND APPARATUSES FOR KARAOKE

(71) Applicant: STEMIT, INC., Berkeley, CA (US)

(72) Inventors: Joshua D. Kaplan, Berkeley, CA (US); Leonid Fedotov, Auburn, CA (US); Anthony Montenegro, New Milford, NJ (US); Jayesh Rathod, Ahmedabad (IN); Aakash Soni, Ahmedabad (IN); Maciej Zielinski, Warsaw (PL)

(21) Appl. No.: 19/540,295

(22) Filed: Feb. 13, 2026

Related U.S. Application Data
(60) Provisional application No. 63/758,141, filed on Feb. 13, 2025.

(51) Int. Cl. G10H 1/36; G06Q 10/109

(52) U.S. Cl. CPC G10H 1/365; G06Q 10/109; G10H 2210/005; G10H 2220/011; G10H 2220/101; G10H 2240/305

(57) ABSTRACT

A karaoke system to enable karaoke performers to acquire and practice songs with specific backing tracks, some of which may be derived from the masters. The karaoke systems and methods described herein allow the user to perform at any karaoke venue using the same, familiar backing song they have practiced with by enabling the users to bring such backing tracks with them to the karaoke venue. At a high level, the karaoke system comprises a computer server that is coupled to a telecommunications network that provides one or more original master recording stems created by extracting one or more individual instrumental and/or vocal tracks from original master recordings in response to a user request, and coupled to the same telecommunications network is a karaoke station and a mobile device, both of which receive karaoke services from the computer server.

### CROSS-REFERENCE TO RELATED APPLICATIONS

This application claims the benefit of the filing date of U.S. Prov. Pat. App. Ser. No. 63/758,141, filed Feb. 13, 2025, the entire disclosure of which is incorporated herein by reference.

### BACKGROUND OF THE INVENTION

### Field of the Invention

This disclosure is related to the field of entertainment, and in particular, karaoke.

### Description of the Related Art

Karaoke is a form of interactive entertainment where participants sing along to pre-recorded backing tracks of popular songs, typically with lyrics displayed on a screen to guide the singer. Originating in Japan in the 1970s, karaoke has spread across the globe. Once considered a niche activity, karaoke is now a mainstream social phenomenon.

The appeal of karaoke lies in its ability to provide a communal experience, encouraging social interaction, boosting confidence, and offering a fun, informal way for people to express themselves musically, regardless of skill level. Karaoke has become a staple offering in all types of venues, ranging from bars and restaurants to dedicated karaoke bars designed around the karaoke experience. Karaoke is also now available even in private gatherings due to the development of home karaoke machines and digital apps for mobile devices, which further expand its reach.

In a commercial setting, the typical karaoke experience involves a combination of audio-visual technologies that create an immersive, interactive environment for participants. Most commercial venues feature a karaoke machine connected to a public address sound system. The machine plays instrumental tracks of popular songs, known in the industry as “backing tracks” or “karaoke tracks.” These tracks have the familiar instrumental melodies of popular songs but without the original vocals, which are instead supplied by the participants. The machines are usually equipped with microphones for the singer and a video display that projects lyrics in sync with the music in case the performer doesn't know, or forgets, the lyrics. These systems may include audio processing equipment or software to mix the vocals with the backing tracks, and some offer vocal effects, such as reverb and echo, to enhance the singer's performance.

The karaoke machine itself typically operates with either a hard drive or cloud-based system that stores, or can access on-demand, an extensive library of songs across multiple genres, allowing users to select the tracks via touchscreens or mobile apps. In many cases, the karaoke machine is curated by an attendant, who screens song selections and queues the performers. Modern karaoke setups often use digital software to handle song selection and queue management efficiently. In addition to the audio-visual components, many venues also offer stage lighting, large screens, and sometimes even props to add to the performance atmosphere. Behind the scenes, sound engineers or automated systems adjust the acoustics to ensure the singer's voice blends well with the background music, providing a professional experience. This integration of technologies has made karaoke a seamless, user-friendly activity, contributing to its lasting appeal in commercial environments.

Although karaoke is widely enjoyed, it is not without its challenges. In particular, the tracks used by performers are not master recordings. Master recordings are the original, official recording of a song or piece of music from which all copies are made. It is the definitive version. Masters are ordinarily professionally recorded and produced in a studio using high-quality equipment and an carefully managed acoustic environment, but recordings of live performances can also be “mastered” for making copies for distribution. Master recordings, especially studio masters, usually capture the full dynamic range, clarity, and detail of the audio as originally performed and captured, prior to format changes that can result in data loss, such as compressions for specific distribution formats. These high-fidelity recordings are usually recorded and mixed by professional audio engineers, and are the versions of the songs that the general public knows best from albums and radio. In the music industry, it holds significant artistic value because, as the original master song, it is generally regarded as the highest-quality version of the song, and it holds important legal rights because it is the definitive reference for reproducing the music in various formats. The terms “master,” “master recording,” and “studio master” are often informally and interchangeable to refer to the same concept, and are not necessarily limited to a studio-recorded performance (e.g., mastering live shows).

However, karaoke machines don't use these original master recordings. For one, the master is protected by copyright laws which would require the acquisition of a complex and expensive set of rights from the owner of the master, which is typically a record label. However, under U.S. law, most songs can be re-recorded as covers without going through potentially expensive negotiations with record labels by paying a modest licensing fee, known as the compulsory license or mechanical license. Also, since the masters usually contain mixed instrumental and vocal tracks, they are often unsuitable for use in karaoke, where the original recorded vocals will compete with and drown out the karaoke performer. It is thus easier, cheaper, and more efficient to simply produce (or license) new instrumental-only tracks made specifically for karaoke purposes.

But these tracks often differ from the popular versions people know by heart. Sometimes these changes are for the benefit of the karaoke performer, such as to lower the key to a range more suitable for non-professional performers. But there are often other changes as well, such as changes to tempo, instrumentation, backing vocals, and so forth. For an untrained performer especially, these changes, even if subtle, can confuse the unpracticed karaoke performer and throw him or her off, especially if he or she is accustomed to singing to the specific arrangement of the original recording. This can frustrate performers and negatively impact the performance.

Another challenge is variability in the quality and setup of karaoke machines and audio systems. Poorly tuned equipment, imbalanced mixes, and venues with poor acoustic environments can make it difficult for singers to hear themselves properly. This can increase the degree to which performers are off-key, even for skilled singers, leading to awkwardness and discomfort, and substantially detracting from the joy of the performance.

Another common challenge, especially in busy venues, is queuing. When there are many eager performers, the wait time can grow lengthy, and in venues where a curator manages the song order, a long queue can become frustrating. Those waiting may lose interest due to the delays, which can diminish the overall enjoyment of the experience. This is especially true if a participant doesn't know when his or her turn will start, or if the karaoke machine even has their song of choice, much less what quality the backing track will be.

Also, inconsistencies in equipment and user interfaces can create problems. Different karaoke machines, sound systems, and interfaces may have very different sound quality, leading to uneven performance experience, and outdated or low-quality song libraries may lack newer tracks, or in some cases have backing tracks of such dubious quality that the song is barely recognizable. This can make it difficult for participants to enjoy the moment as intended.

In some cases, users may want to bring their own karaoke tracks, but existing technology lacks this flexibility. Karaoke machines rely on pre-installed song libraries stored on disk, or, at best, cloud-based systems in which low-quality, low-bitrate backing tracks are downloaded on demand. Even if a singer has a high-quality karaoke track to perform, there is usually no way to make use of external media, such as USB drives or a wireless transfer from a mobile device.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems and methods for extracting and using master recordings as backing tracks in karaoke applications, and other improvements to the karaoke technology stack, including a new type of karaoke machine that interfaces directly with a mobile app to improve the experience of selecting and queueing for performance, and which allows performers to practice with a familiar backing tracks outside of a karaoke venue and use that same track at any karaoke venue.

In an embodiment, the karaoke system comprises: a computer server communicably coupled to a telecommunications network and providing via the telecommunications network, in response to user requests, one or more original master recording stems created by extracting one or more individual instrumental and/or vocal tracks from original master recordings; a karaoke station disposed in a karaoke venue, the karaoke station communicably coupled to the telecommunications network; a user device associated with a user, the user device comprising a processor, a microphone, an imaging system, and being communicably coupled to the telecommunications network; a computer server communicably coupled to the telecommunications network; wherein the computer server provides karaoke services to the karaoke station and the mobile devices via the telecommunication network.

In another embodiment, the user installs a karaoke application on the user's device. In some embodiments the user installs such a karaoke application on the user's device by scanning a visual code displayed at a karaoke venue.

In other embodiments, the user configures the karaoke application with a user profile for the user, the user profile comprising one or more of: a phone number, an e-mail address, a zip code or other geographic locator, payment card information or payment system information, a user photo, a user avatar, a user stage name or handle.

In more embodiments, the karaoke station comprises an outer shell, a display, and a user interface. The display screen of some embodiments comprises a screen or touch screen.

In further embodiments, the karaoke station comprises an imaging system for capturing image data of a user. In other embodiments, the karaoke station comprises a central processing unit, a non-transitory machine-readable memory, a non-transitory machine-readable storage, network communication equipment, and one or more external interfaces. And in some embodiments, the one or more external interface comprises interfaces configured for audio, visual, or audiovisual electronic communication.

In more embodiments, the karaoke station further comprises a video and audio capture system configured to record audio and visual elements of a karaoke performance.

In an embodiment, the karaoke station further comprises a short-range communication transceiver. In some embodiments, the user can wirelessly check-in to the karaoke station via the short-range communication transceiver via the user device.

In other embodiments, the karaoke application provides a plurality of functions to the user. In some embodiments, the plurality of functions is provided via a graphical user interface. In other embodiments, the plurality of functions includes a home page having a plurality of interface controls for accessing other functions in the plurality of functions.

In still further embodiments, the plurality of functions comprise one or more of the functions selected from the group consisting of: calendar, lounge, live, ordering food and beverages, channels, and recording.

In more embodiments, the plurality of functions comprise one or more of the functions selected from the group consisting of: search, chat, alerts and/or notifications, profile setup, calendar, lounge, live, ordering food and beverages, channels, venue, and recording.

In some embodiments, operating one of the interface controls causes the application to display an interface for the function.

In other embodiments, the interface for the calendar function comprises a calendar interface comprising interface elements and/or controls for choosing a date, filtering results, displaying events and/or event details, scheduling events, and signing up for events.

In more embodiments, the plurality of functions includes the user selects the venue from an interface by entering text in a search box, selecting from a drop-down, searching a map interface, or geolocating the user via a geolocation system of the user device.

In still more embodiments, the user manipulates said interface to check in at said venue. In some embodiments, after the user checks in to the venue, said the receives access to functions, features, events, channels, and options associated with the venue.

In further embodiments, one of the functions is a now playing function which displays on the user device an identification of a user currently performing, and/or a song currently being performed, at the venue.

In more embodiments, one of the functions is adding the user to a performance queue for the venue by searching for and selecting a song for the user to perform at the venue and/or one or more of the original master recording stems provided by said computer server for the user performance.

In other embodiments, the system provides the one or more original master recording stems via the telecommunications network and, when the user reaches the front of the performance queue, plays the one or more original master recording stems on an audio system of the venue.

In further embodiments, while system plays the one or more original master recording stems on an audio system of the venue, the user performs said song using said microphone of the user device and lyrics for the song are displayed on a display of the user device in synchronization with playing the one or more original master recording stems.

In still more embodiments, the user performance is captured by said audio and visual capture system.

In an embodiment, the captured user performance is accessible for replay in the app. And, in some embodiments, the user is charged a fee in association with the user performance.

In other embodiments, the system comprises venue administration application software configured for managing the karaoke system at the venue.

In some embodiments, the venue administration application is a web application accessible via a user interface displayed on an administrative user device and/or the karaoke station.

In other embodiments, an administrative user of the venue administration application can manipulate the user interface to manually edit the performance queue.

In other embodiments, an administrative user of the venue administration application can manipulate the user interface to manually edit the performance queue.

In more embodiments, the plurality of functions includes an interface for practicing a song performance.

In further embodiments, the plurality of functions includes delivering advertising or marketing messages to the user, the messages based at least in part on the venue and/or a geographic location of the venue.

In still further embodiments, the plurality of functions includes providing information about the venue, the information comprising one or more of hours of operation and food and drink menus.

In other embodiments, the plurality of functions includes ordering food and drink at the venue for delivery to the user at the user's location in the venue.

In more embodiments, the plurality of functions includes providing performance feedback to the user. In other embodiments, the plurality of functions includes virtual karaoke.

In other embodiments, the virtual karaoke feature comprises a virtual lounge interface providing interactive engagement with other users.

In more embodiments, the virtual karaoke feature comprises virtual stages having features comprising one or more of a rendering of a venue stage, a representation of other users viewing said virtual stage, a live performance by another user at the venue stage, and one-directional and/or interactive engagement with the performing user.

In some embodiments, the user can perform on a virtual stage. In some embodiments, one or more virtual stages is private, personal, and/or curated.

In an embodiment, the computer server is communicably coupled to a data store, the data store comprising a database of original master recording stems created by extracting individual instrumental and/or vocal tracks from original master recordings, and the providing via the telecommunications network, in response to user requests, one or more original master recording stems created by extracting one or more individual instrumental and/or vocal tracks from original master recordings comprises retrieving a requested original master recording stem from the data store.

In some embodiments, the computer server comprises or is communicably coupled to a real-time, on-demand stemming module or service, and the providing via the telecommunications network, in response to user requests, one or more original master recording stems created by extracting one or more individual instrumental and/or vocal tracks from original master recordings comprises creating a requested original master recording stem in real-time, on-demand via the stemming module or service.

In other embodiments, the requested original master recording stem is requested via a user request received via the telecommunications network at the computer server.

In more embodiments, the user request comprises an indication of an original master recoding from which the original master recording stem is requested.

In further embodiments, the user request further comprises indication of one or more instruments to be included in the requested original master recording stem.

### BRIEF DESCRIPTION OF THE DRAWINGS

FIG. 1 provides a schematic diagram of an embodiment of systems, methods, and apparatuses for enhanced karaoke according to the present disclosure.

FIG. 2A provides an isometric perspective view of a karaoke station according to the present disclosure.

FIG. 2B provides a front elevation perspective view of an alternative embodiment of a karaoke station according to the present disclosure.

FIG. 2B provides a front elevation perspective view of an alternative embodiment of a karaoke station according to the present disclosure.

FIG. 2C provides a side elevation perspective view of the embodiment of FIG. 2B.

FIG. 2D provides a front-side elevation perspective view of the embodiment of FIG. 2B.

FIG. 2E provides opaque and transparent front-side elevation perspective views of the embodiment of FIG. 2B depicting user device interaction.

FIG. 2F provides a front-side elevation perspective view of the embodiment of FIG. 2B with the front cover of the housing open.

FIG. 2G provides a detail view of a rotary lock for the embodiment of FIG. 2B.

FIG. 2H provides transparent versions of the views of FIGS. 2B, 2C, and 2D.

FIG. 2I provides an isolated view of electronics for the embodiment of FIG. 2B without a housing.

FIG. 3 provides an isometric perspective view of an alternative embodiment of a karaoke station according to the present disclosure.

FIG. 4A provides a block diagram of a wiring schematic for an embodiment of a karaoke station according to the present disclosure such as that depicted in FIG. 2A.

FIG. 4B1-4B2 provide a block diagram of a wiring schematic for an embodiment of a karaoke station according to the present disclosure such as that depicted in FIGS. 2B through 2I.

FIGS. 5-29 provide embodiments of a mobile devise application for implementing the systems and methods for karaoke according to the present disclosure.

FIGS. 31-32 provide embodiments of a virtual stage environment rendered within the application, allowing users to attend or participate in karaoke performances in a simulated venue setting according to the present disclosure.

FIGS. 33-34 provide embodiments of user interface elements and interaction options for virtual performances, including audience feedback, performance queues, and user engagement features such as tipping, rating, or commenting according to the present disclosure.

FIG. 35 provides an embodiment of a system architecture for implementing the methods according to the present disclosure.

FIGS. 36A-36B provide an embodiment of a method for providing enhanced karaoke according to the present disclosure.

FIG. 37 provides an embodiment of a supporting system according to the present disclosure.

FIGS. 38A-38F provide embodiments of a station dashboard according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

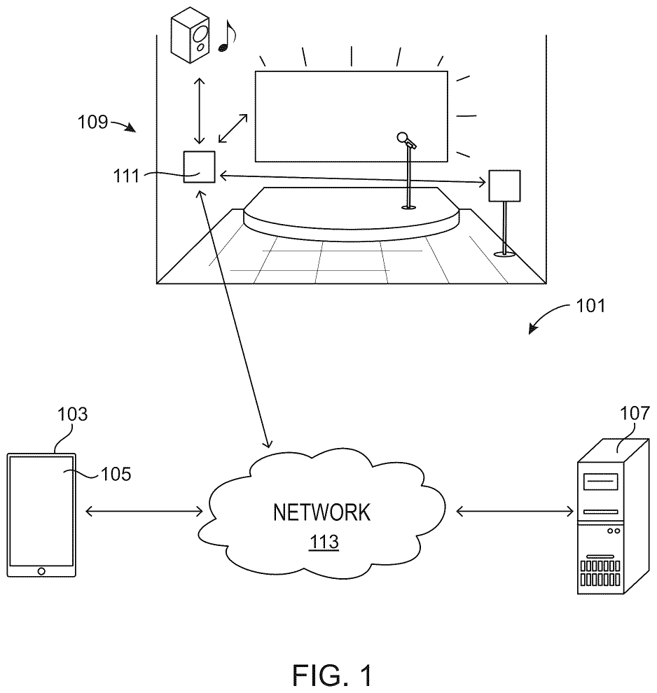

FIG. 1 provides a general schematic of systems (101) and methods described herein, including: a karaoke station (111) located in a venue (109) and communicating with other devices over a network (113). Those devices may include, but are not necessarily limited to, a user device (103) with application software (105) programmed to interact and interface with the karaoke station (111) over the network (113), and a server computer (107) providing various on-line and other computing services, including providing on-line or network services to the user device (103) and karaoke station (111) over the network (113). These and other elements are described in further detail elsewhere herein.

A goal of the systems and methods described herein is to enable karaoke performers (who may be more simply referred to as “users” herein) to acquire and practice karaoke songs with specific backing tracks, which may also be derived from the masters with which they are familiar, and to bring and use those specific backing tracks to a karaoke venue and use them there. The systems and methods might be best understood by exploring its features sequentially from the point of view of the user experience. It should be noted that while most users will be karaoke performers (e.g., end users), there may be other classes of users as well, including one or more of: venue owners and/or managers who operate karaoke stations and manage events (e.g., administrative users for venues), super-users (e.g., platform owners administering and managing the overall-system used by all venues and end-users), and artists/professionals and/or their managers or catalog administrators.

In the preferred embodiment, the systems, methods, and devices described herein use master recordings instead of covers. In a further preferred embodiment, this is done ephemerally by isolating stems on-demand using on-board hardware and software within the station. This protects the security of the original master recordings and the stems isolated from them by avoiding the need to store either on user devices or indefinitely in large, centralized databases in cloud storage, where they are susceptible to be misappropriated, ransomed, or intercepted during transmission. Further, in the preferred embodiment, the isolated stems are maintained in local memory/storage ephemerally, being deleted shortly after use (e.g., immediately after a performance, or during routine maintenance at the end of the day, week, or on another schedule), reducing the possibility of misappropriation or misuse.

A new user would generally begin by installing on a user device (103) of the user application software (105) programmed to implement some or all of the systems and methods described herein, and to interoperate and communicate with one or more karaoke stations (111). In the embodiments described herein, the application (105) is the primary interface for customers participating in karaoke events at venues and enables various features, which may include discovering events, selecting and requesting songs, joining live performance queues, performing karaoke, and engaging with the platform through recordings, notifications, and social sharing. Generally, the application (105) is designed and configured to deliver a seamless, real-time experience synchronized with venue karaoke hardware and backend systems. These and other elements are described elsewhere herein.

The software (105) may be acquired by download from an on-line distribution platform, like the Apple™ or Google™ store. The user may register by providing certain required information, such identifying information, a phone number, an e-mail address, a zip code or other geographic locator, and/or optionally payment card information. Alternatively, the user may rely on built-in payment systems associated with the user device (103), such as Apple Pay. Alternatively, the user may register without downloading the app (105), such as by visiting an associated web site, though the user will ultimately use the app (105) when at a compatible karaoke venue (109). The user information is generally transmitted to the server computer (107) via the network (113), and retrieved and verified therefrom as needed. Generally, the user may be expected to verify his or her registration through an e-mail account or other verification technique, to reduce fraud, identify theft, misuse, and the like.

Users may download and install the application (105) before arriving at a venue (109) having a karaoke station (111), but many users will first encounter the app (105), and the ability to use it with compatible karaoke stations (111), upon arriving at a venue (109) that has a compatible karaoke station (111). In such circumstances, the venue (109) may provide signage or directions to the user to download and install the app (105) and to register to participate, such as by providing optical code (e.g., a QR code) that can be scanned using imaging system in the user device (103) to locate and download the current version of the app (105).

In some embodiments, the karaoke station (111) may provide for additional channels to be made available to the user via the app (105) and/or station (111). Such channels may comprise a DJ channel, a music trivia channel (which can use original master song stems for participants to listen to and then guess the song from which the stem was extracted), and open mic night (where a musician can book a session, pay a fee, and then perform a song using backing stems of original master recordings).

In some embodiments, each karaoke station (111) may have its own associated unique identifier, which is associated with the optical code. This code may be tracked so that data can be collected regarding user registration at various venues (109). Alternatively, the user's geolocation may be determined by the user device (103) and submitted with the user's registration information, and used to determine which venue (109) the user registered in, and the identifier for the associated karaoke station (111).

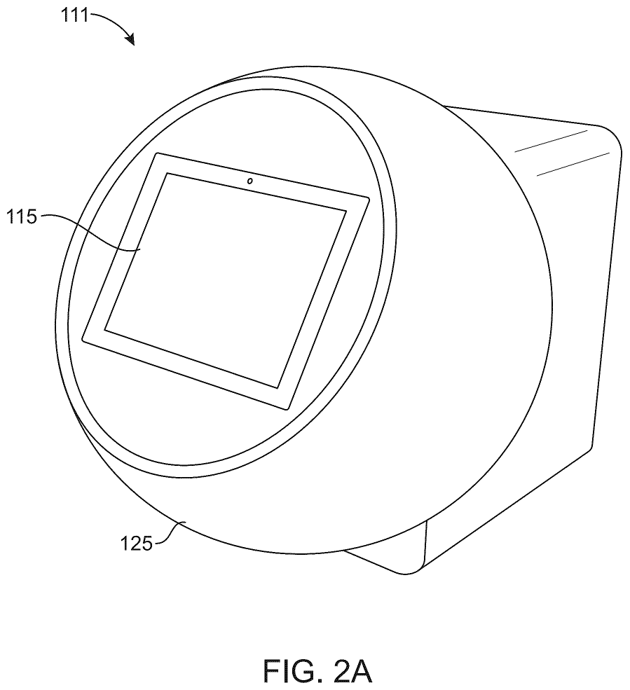

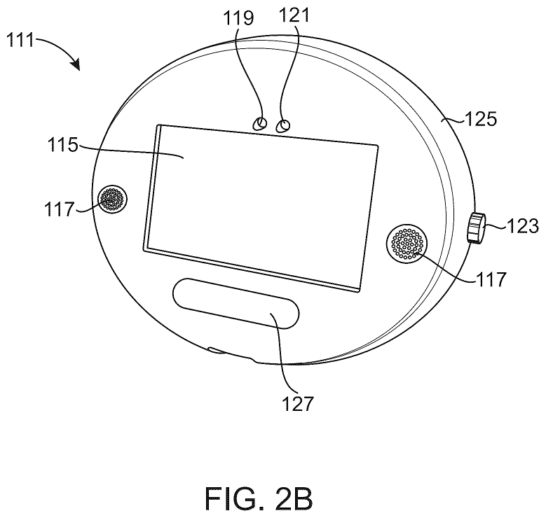

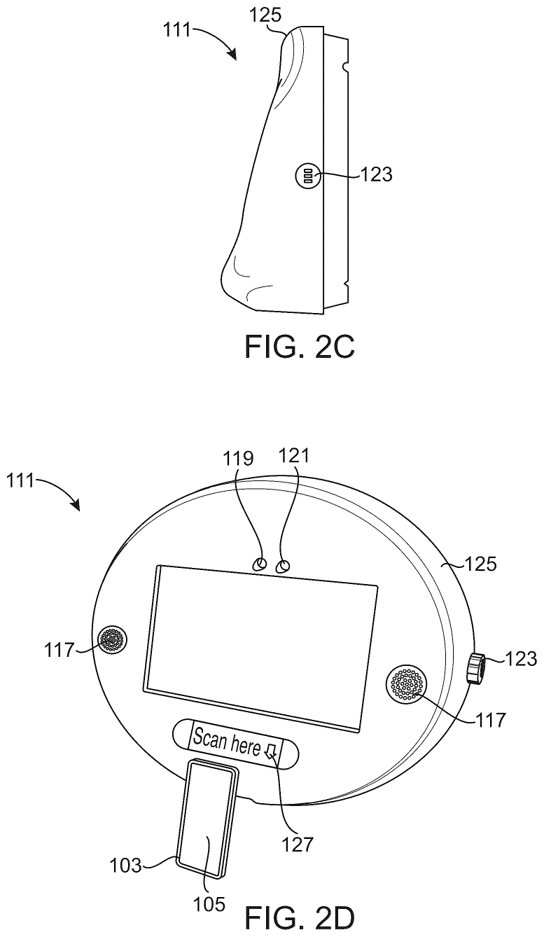

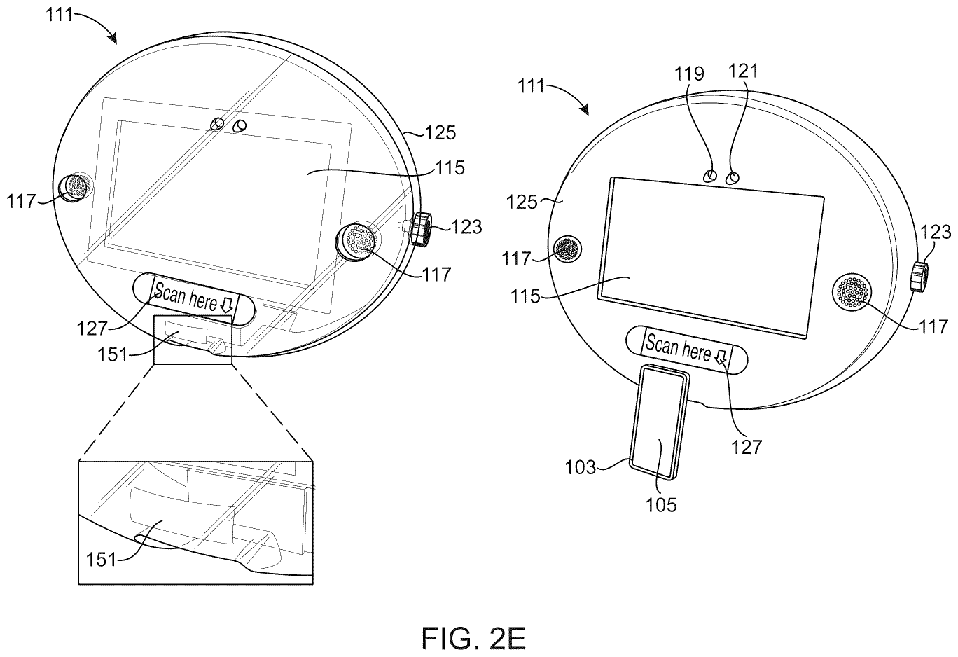

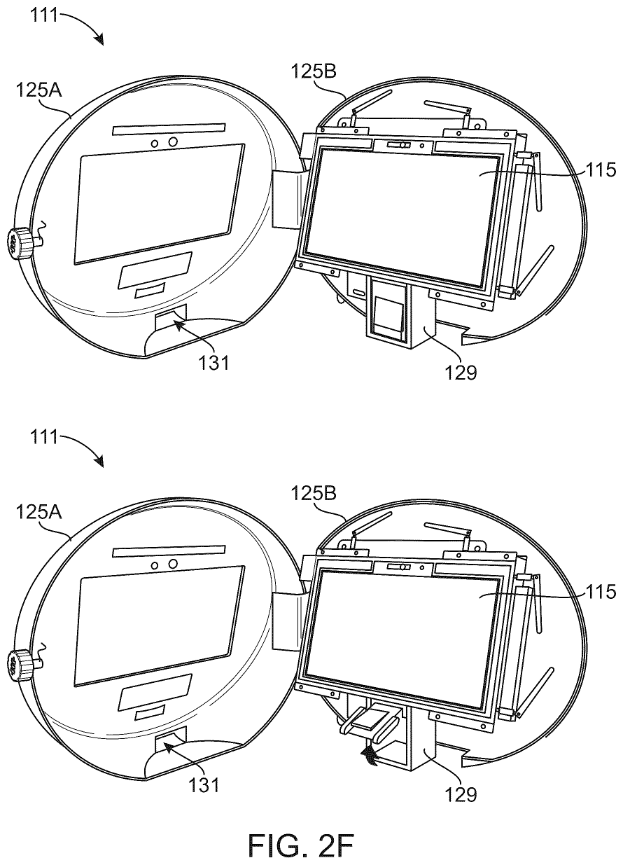

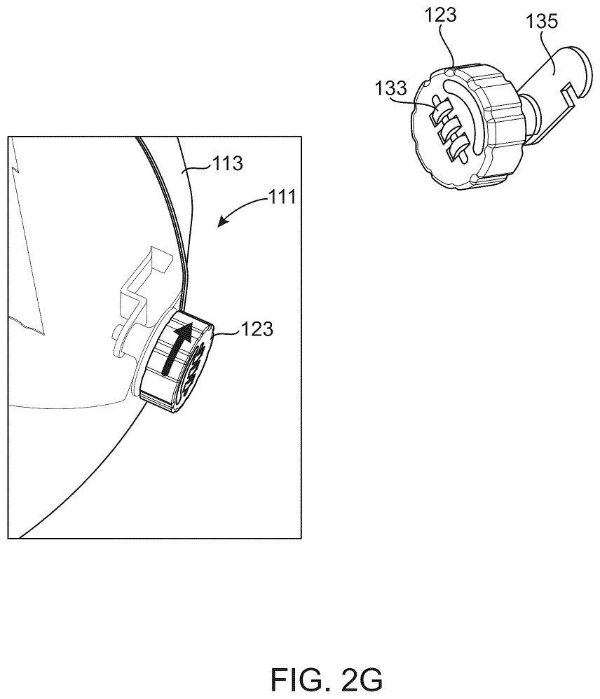

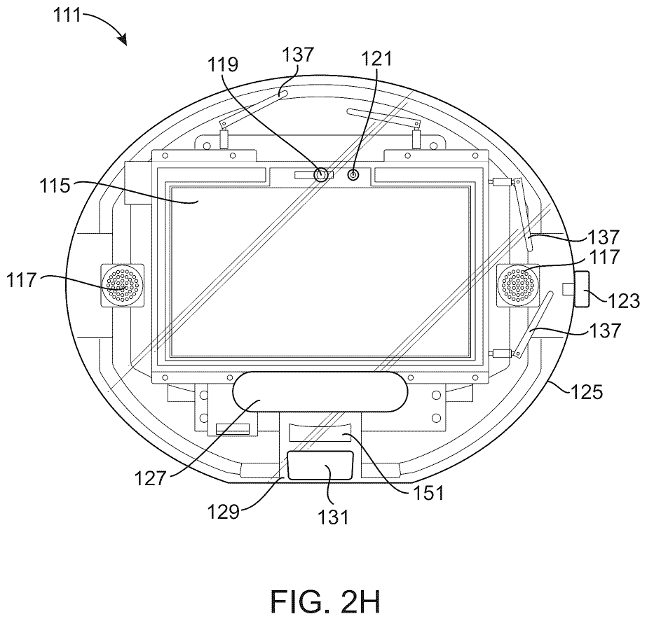

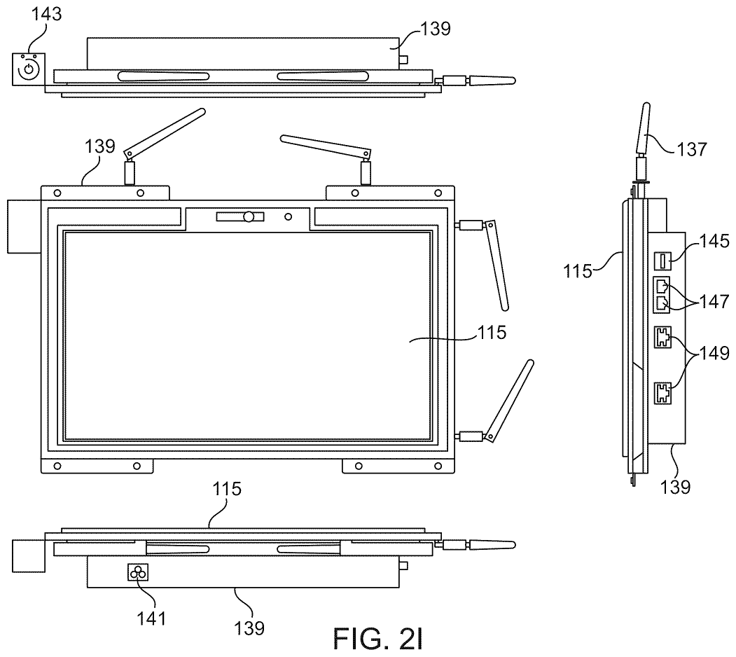

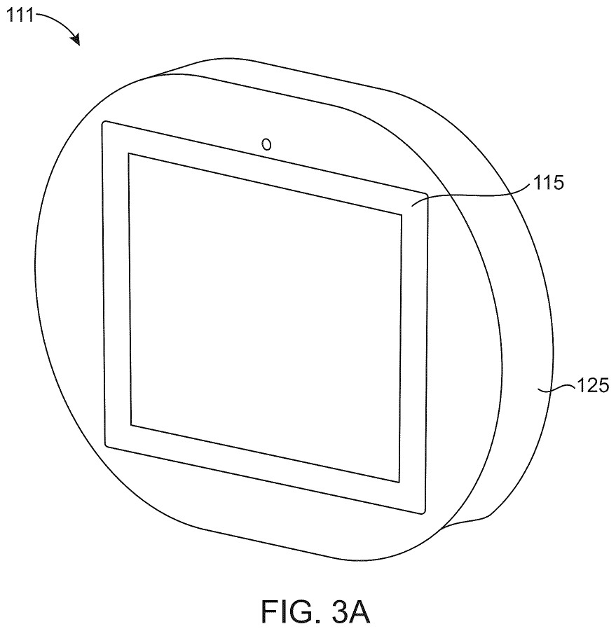

In the depicted embodiments of FIG. 2 depicts an embodiment of a karaoke station (111) according to the present disclosure, and FIG. 3 depicts an alternative embodiment of a karaoke station according to the present disclosure. Both of the depicted embodiments generally comprise an outer shell or housing (125) and a user interface (115). In the depicted embodiments, the outer shells are made of a hardened material that is resistant to unintended deformation, as well as moisture penetration and other sources of potential damage to the electronics stored within. The particular shape and configuration of the housing (125) may vary from embodiment to embodiment. As can be seen in FIG. 2, the depicted housing (125) includes a flat bottom sized and shaped to allow the depicted station (111) to rest on a surface. By contrast, the depicted embodiment of FIG. 3 includes a housing (125) adapted for hanging on a wall or other vertical surface.

The depicted embodiment of FIGS. 2B, 2C, 2D, 2E, 2F, 2G, 2H, and 2I comprises a touch screen (115) and housing (125), as well as at least one external audio emitting device (117), such as a speaker, along with a front camera (119) and proximity sensor (121). The front camera (119) and proximity sensor (121) may be used for various features described elsewhere herein, including but not limited to authenticating users and/or and setup. The depicted interface screen (115) is a 15.6″ LCD projective capacitive touch interface having a resolution of 1920×10180, but other sizes, resolutions, and interfaces are possible depending on the hardware chosen. The depicted housing (125) is plastic, which is rugged, environmentally tolerant, and has adequate environmental tolerance and heat transmission properties. The depicted embodiment further comprises a second display (127), which may provide messages to users (e.g., instructions, marketing, etc.). Also shown is a physical system lock (12), described in further detail elsewhere herein. FIG. 2H depicts the karaoke station (111) in transparent view, showing also internal antennae (137) attached to the internal electronics to facilitate communication via one or more transceivers or other wireless communication systems. Additionally, wired communication may be possible using a physically connected line connected to a corresponding communication port. By way of example and not limitation, this may be an ethernet cable plugged into an ethernet port (not shown).

FIG. 2E depicts the karaoke station (111) in transparent view in use with a user device (103) having an associated application (105). The depicted view illustrates one possible placement/location for a short-range communication transceiver (151), such as (but not necessarily limited to) a near-field communication (NFC) antenna for communicating wirelessly with a user device (103) during set up, configuration, authentication, and/or ordinary use by end-users, as described elsewhere herein. As shown in FIG. 2E, a display (115) and/or (127) may be used to provide direction or instruction to the user. In the depicted embodiment, a smaller, secondary display (127) disposed beneath the primary display (115) provides the user with direction to scan the user device (103) to begin using the karaoke station (111).

FIG. 2F depicts the karaoke station (111) whose housing is comprised of two shells (125) and (125B). A first shell (125A) comprises a cover having various apertures facilitating the use of electronic (e.g., apertures positioned to align with the location of a camera (119), proximity sensor (121), and the displays (115) and (127). A second shell (125B) comprises a housing for receiving and mounting electronic elements. In the depicted embodiment of FIG. 2F, the two parts of the shell (125A) and (125B) together form the housing (125) and are hingedly connected so that the cover/first shell (125) can swing open for maintenance and service. Also shown in FIG. 2F is an internal printer (129). The depicted printer is a thermal printer having a storage compartment for paper, and the first shell (125A) has a corresponding aperture (131) for passage of the paper. The paper printer may be used for a number of functions, including but not necessarily limited to printing paper receipts, tickets, coupons, and optical scanning codes, which may be used to facilitate redemption of offers within the venue housing the station, or in another value. By way of example and not limitation, the optical scanning code may be a QR code or user identification code usable to redeem offers for food, beverages, or performance tokens (described elsewhere herein), or to nearby or other external values, such as local restaurants.

FIG. 2G depicts a detail view of a physical rotary lock (123). In the depicted embodiment, the rotary lock (123) is disposed on a side of the housing (125) opposing the side of the hinged connection, and is configured to hold the first shell (125A) and second shell (125B) together in a locked configuration to prevent unauthorized tampering. The depicted lock (123) comprise a rotary combination dial (133) manipulated by an authorized user to open the housing (125) by releasing a latch (135). This type of lock will be familiar to a person of ordinary skill in the art. This lock (123) is exemplary only and the type, placement, and configuration of the lock (123) may very from embodiment to embodiment. By way of example and not limitation, the housing (125) could be hingedly openable at the top and locked via a padlock disposed through coordinated apertures at the bottom.

FIG. 2I depicts internal electronics without a housing. As can be seen, the internals of the depicted embodiment are essentially a special-purpose computer system including a touch screen (115), a chassis (139) or computer housing (139) adapted to mount the internal electronics within the housing (125). The internal electronics include an interface for operating power on and off, shown as a manually-operated button (143), and ports for power (141), external device interfaces (e.g., via universal serial buses) (145), and various wired communication technologies, such as ethernet (147) and conventional landline (149). Other elements associated with a computer of this nature will be understood by a person of ordinary skill the art even if not shown, including but not necessarily limited to, random access memory, storage, and power supply.

In both embodiments, the interface (115) is a screen or touch screen. Generally this screen will be used to display the current status of the karaoke station (111), such as which song is being performed and which performer is on stage. The particular contents of the display will vary from embodiment to embodiment depending upon the particular needs. Although a screen or touch screen (115) is shown, in alternative embodiments, other interfaces are possible, such as voice activation, tactile buttons, and the like. The karaoke station (111) may further comprise an imaging system which may be used to provide face identification or other biometric scanning to authenticate administrative users. External ports for audio, visual, and/or audiovisual interfaces, such as HDMI, may be included. Such interfaces may allow the station (111) to stream audio and visual content to be displayed on screens or other display devices at the venue simultaneously with, or in synchronization with, audio.

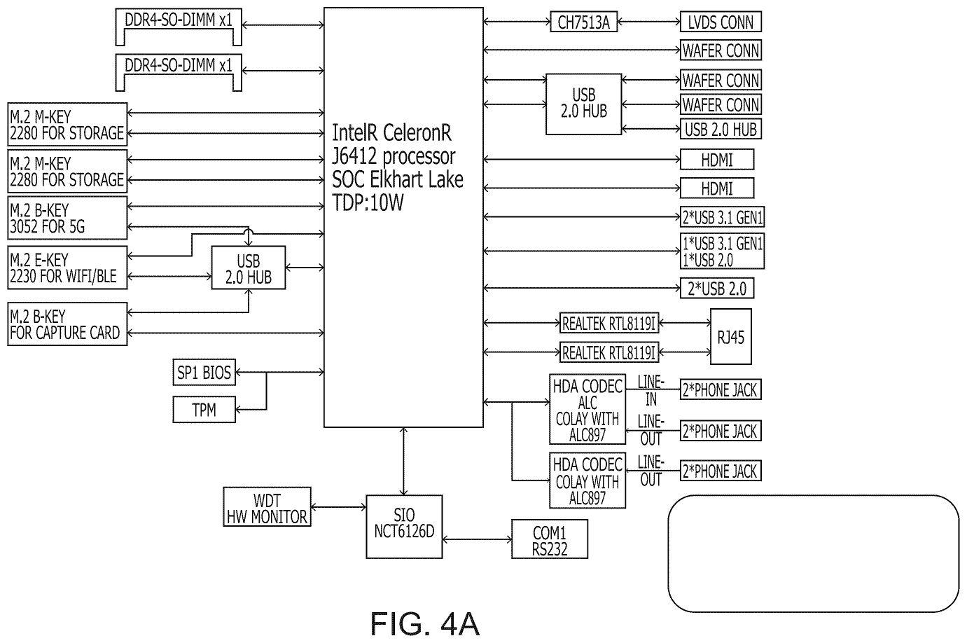

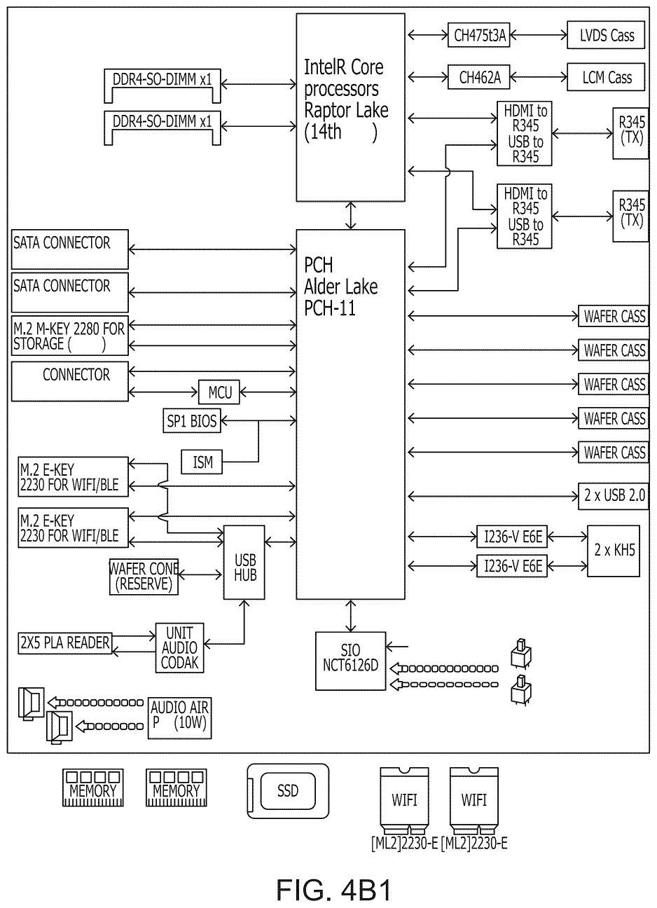

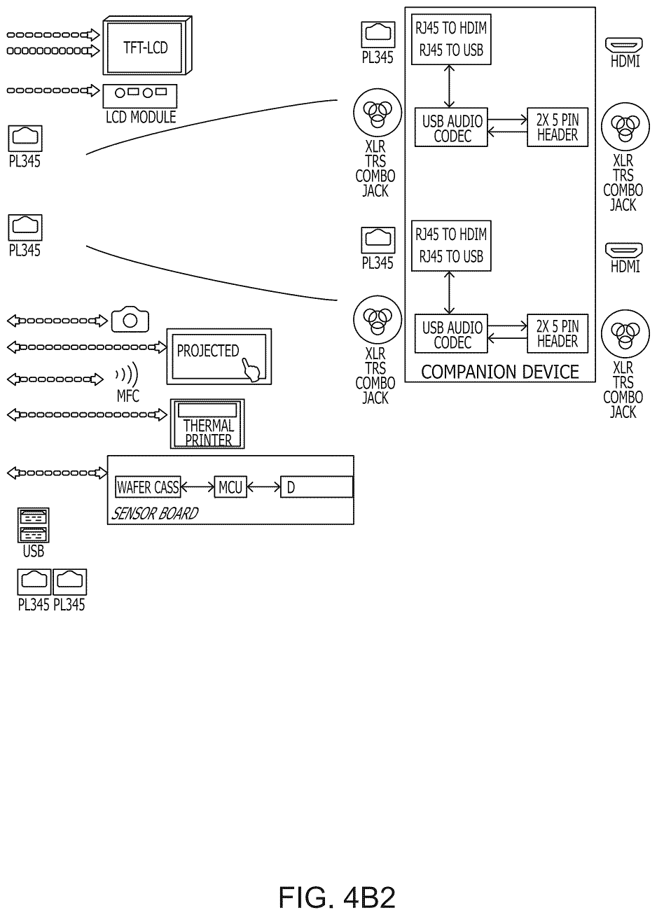

FIGS. 4A and 4B depict block diagrams of internal circuitry for various embodiments of a karaoke station (111). Generally, the karaoke station will have components similar to those of a computer system, as described elsewhere herein, which may include (without limitation) a central processing unit (201), a memory (203), storage (207), network communication equipment (205), external interfaces (209), and a connection to external audiovisual equipment (211), which include, without limitation, a supporting audiovisual box (601). The karaoke station (111) may further include a video capture card or devise (213) for capturing a performance as described elsewhere herein.

In an embodiment, a karaoke station (111) may comprise an imaging system, such as a video camera (119). The camera (119) may be used to capture image data of a user, which can then be used to attempt to visually identify users and match a user physically present at the venue with a user profile. The camera (119) may also be used to capture the user's image, which may then be associated with the user's profile configuration and/or the user's app (105). A proximity sensor (121) may work in connection with camera (119) to determine when a user is nearby to reduce false positives, reduce unnecessary wear, and provide improved facial identification.

In an embodiment, a karaoke station (111) may comprise a short-range communication transceiver (151), such as a near-field communication system (151), which allows users to check-in wirelessly using a mobile phone. The user can then see his or her position in the performance queue, as described elsewhere herein, without having to load up and use a graphic interface. In an embodiment, the system may be configured to issue newly-checked in users a physical or virtual coupons for the venue, such as via a printer (129), which could be redeemed for food, beverages, prizes, performance tokens, and other amenities.

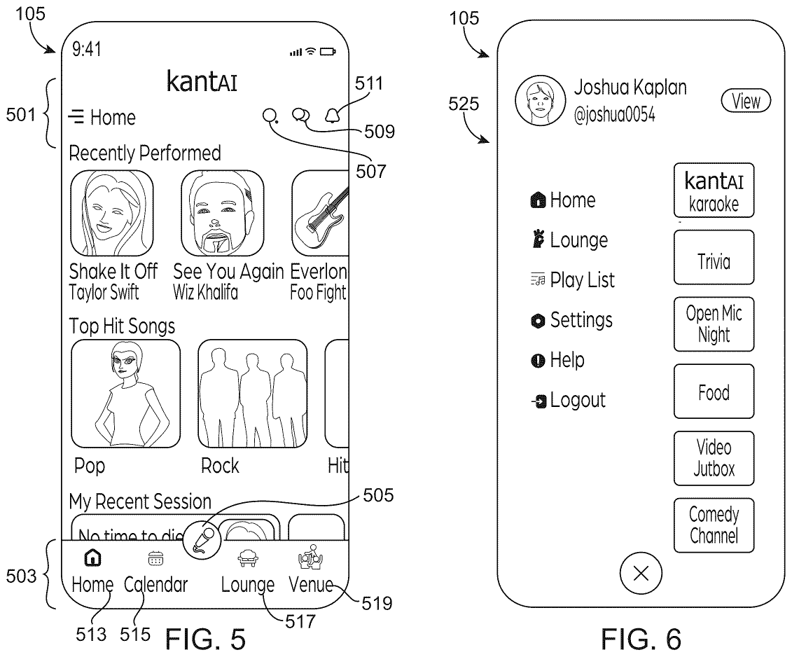

Once a user is registered, the user can manipulate the GUI of the app (105) to use its various features and functions. FIG. 5 depicts an embodiment of a home page or landing page of the app (105). In the depicted embodiment of FIG. 5, the landing page includes some interface elements that may be common across multiple screens of the app, including a top navigation section (501), a bottom navigation section (503), and a performance control (505). These and other elements will be described in further detail elsewhere herein.

Generally, in the depicted embodiment, a top navigation section (501) comprises a “hamburger” menu, comprised of a visualization indicating that the selected element, “home” in the depicted embodiment of FIG. 5, is one item selected from a menu that can be accessed by manipulating the visual element. This dropdown menu technique is now familiar and widely used in the art. In the depicted embodiment other options accessible via this menu include calendar, lounge, live, a control providing access to ordering food and beverages via the app (which may be delivered to the users' location in the venue, e.g., a table or room), a control providing access to a digital calendar for the revenue, access to channels associated with the venue, and recording. However, the particular options available within the menu will vary from embodiment to embodiment depending upon the specific features and functions that have been implemented, and depending upon the design choices of the app publisher and changing trends in app design practices.

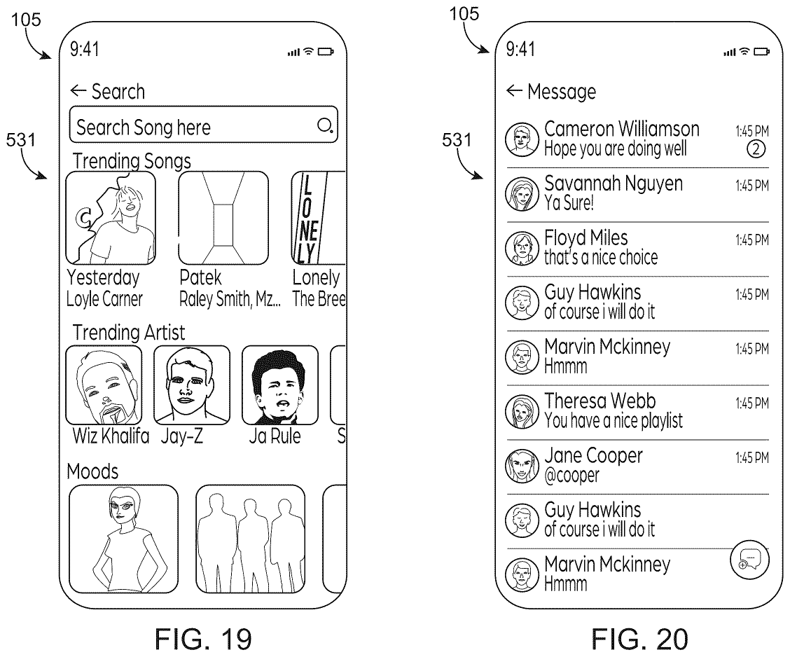

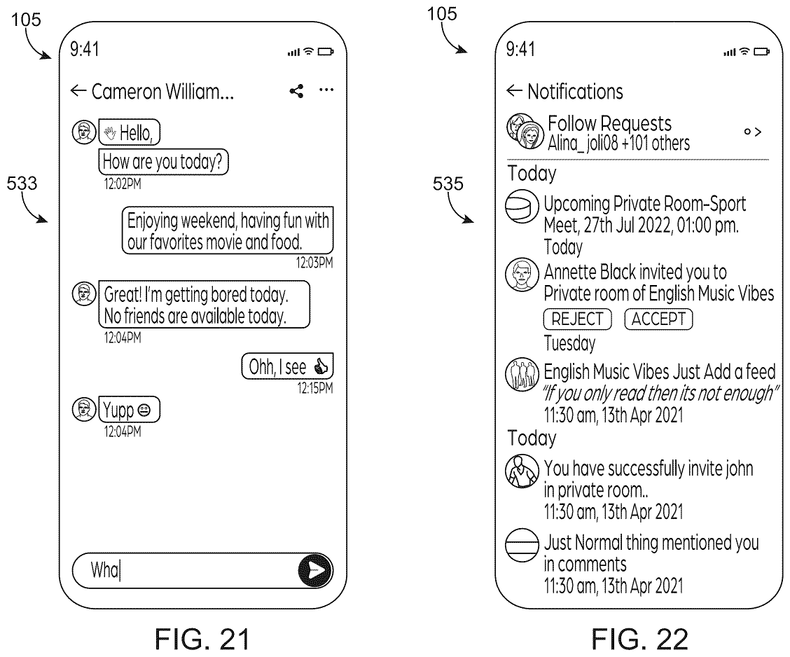

In the depicted embodiment, the top navigation section (501) further includes a search control (507), a chat control (509), and an alert control (511). These controls will be familiar to any user of a mobile app, and provide access to various corresponding features and functions. In the depicted embodiment, operating the search control (507) loads a different screen allowing the user to conduct a search for a song, such as the non-limiting, exemplary embodiment of FIG. 19. In the depicted embodiment, accessing the chat control (509) launches a chat screen, such as that in the exemplary embodiment (533) of FIGS. 20-21. In the depicted embodiment, operating the alert control (511) launches a notification screen such as that depicted in the exemplary embodiment (535) of FIG. 22.

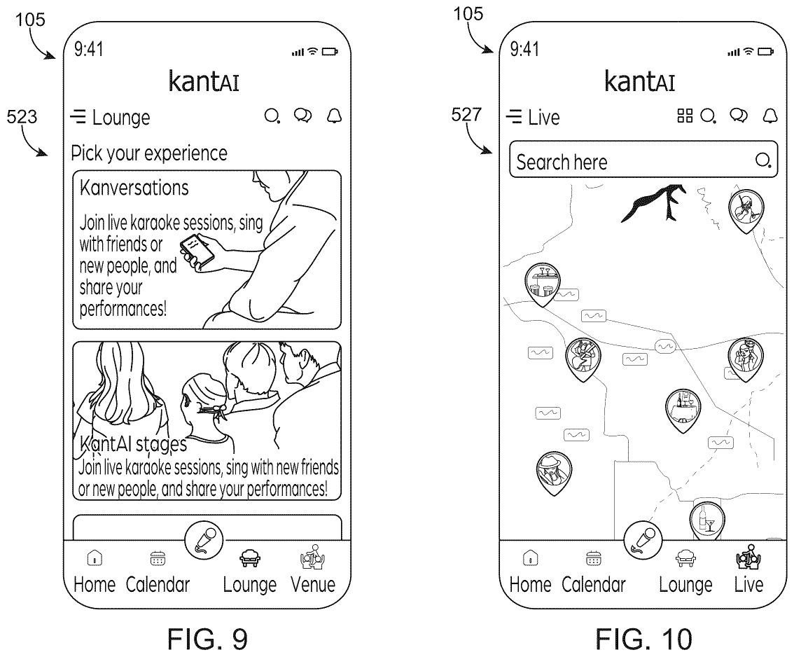

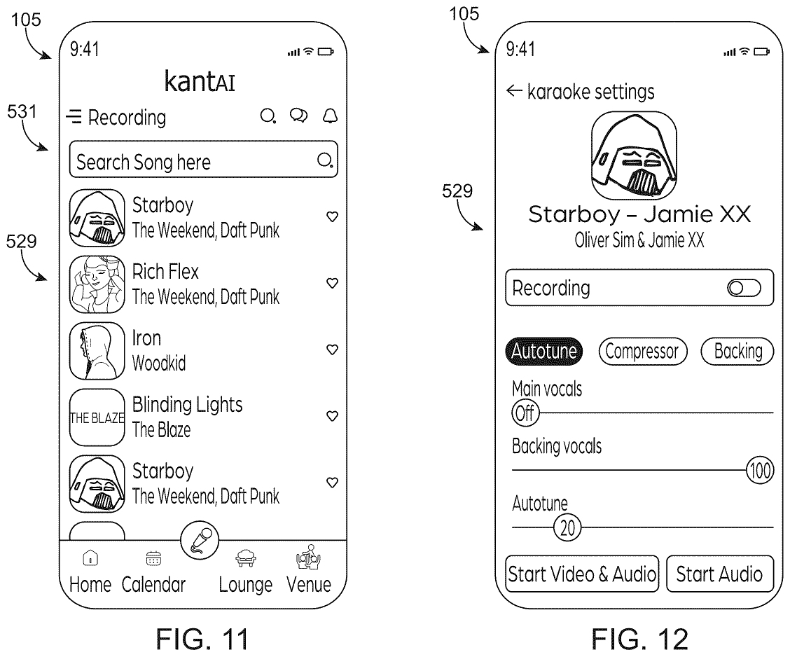

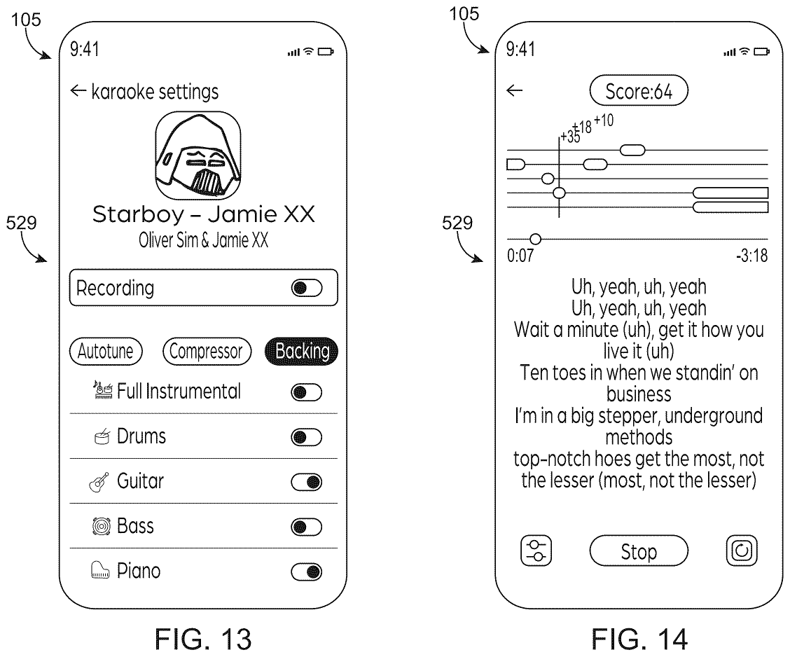

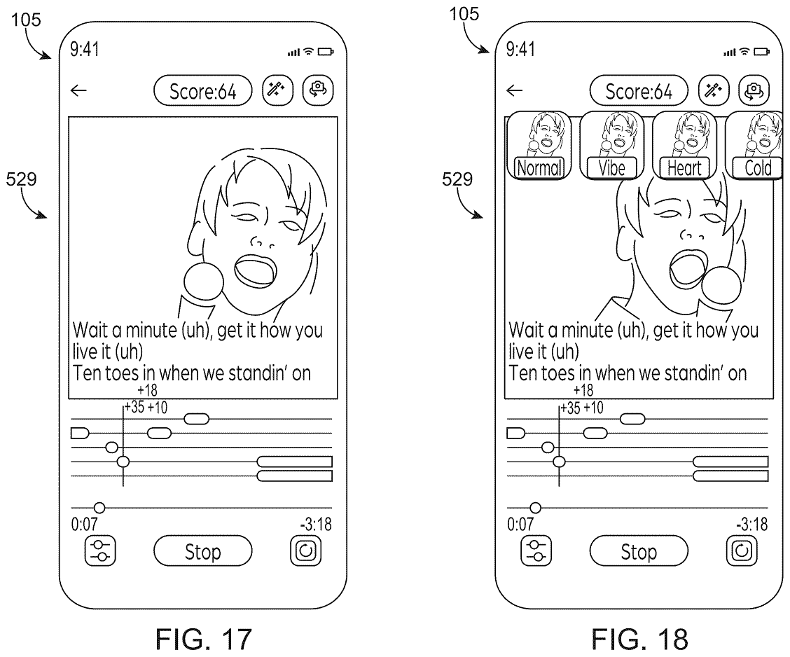

In the depicted embodiment, the bottom navigation section (503) comprises five controls, a home control (513), a calendar control (515), a lounge control (517) and a venue control (519). The depicted home control can be operated to return the app to the depicted home page of FIG. 5. In the depicted embodiment, the calendar control (515) launches a calendar interface such as that depicted in FIG. 8. In the depicted embodiment, the lounge control (517) launches a lounge interface such as that depicted in FIG. 9. In the depicted embodiment, operating the venue control (519) launches a venue interface such a that depicted in FIG. 10. The fifth depicted element is the recording control (505). Operating the recording control in the depicted embodiment launches a recording interface (529) such as that depicted in FIGS. 11-18. These and other features are described in further detail elsewhere herein.

It should be noted that the particular contents of the top navigation section, including the drop down menu and the bottom navigation section may vary from embodiment to embodiment. Likewise, there may be multiple ways to access a specific screen or page of the app through one or more of these mechanisms. In an embodiment, the app may only have one navigation section, combining these or other functions. Additionally, the terms top and bottom are used herein to distinguish the locations of these two sections on the depicted application, but should not be understood as limiting, as physically locating the navigation components elsewhere on the screen is possible and expected in alternative embodiments. That is, in an embodiment, the contents of the top or bottom section may be reversed and one may appear above or below the other, for example.

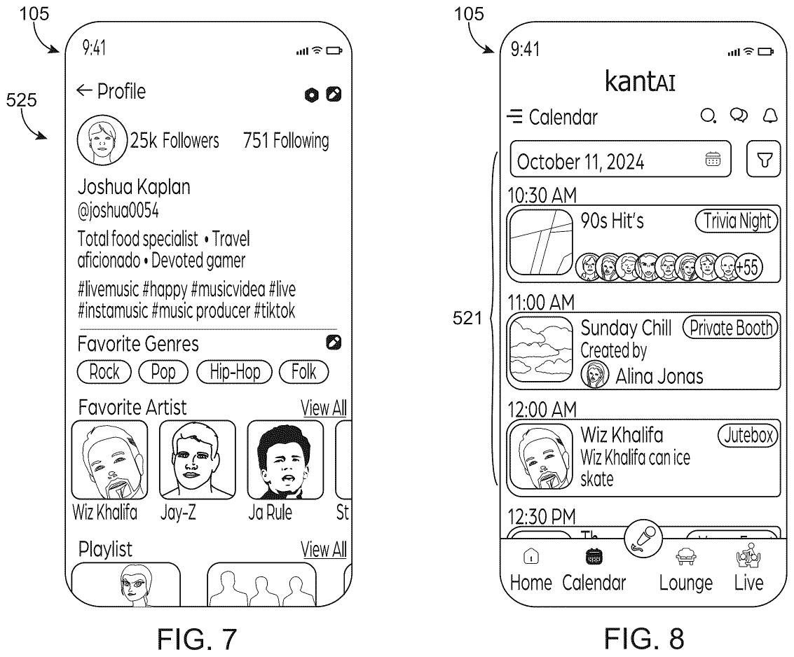

The app (105) may provide a profile set up function. This may allow the user to select a user name or “stage name” to be known by in the app (105) and in associated social networking/social media, provide a user profile photo or select/configure a custom avatar, and provide payment card information or purchase preference information for any purchases the user makes. Users may manipulate a GUI of the app (105) to update and change this information. This information will usually be transmitted to, and centrally stored via, the server computer (107) for later retrieval and use at a karaoke station (111). This facilitates privacy, security, and portability. Exemplary embodiments (525) are shown in FIGS. 6-7. In an embodiment, profile functions and features may include, without limitation, allowing users to control visibility and personalization, profile setup with avatar/photo and username, user preference configuration, public or private profile visibility settings, record/manage voice sample(s) for vocal range detection, storage of vocal range metadata, opt-in and communication preferences for general messages, and artist communications. An embodiment of a calendar interface (521) is shown in FIG. 8. This interface includes a selector for choosing a date, as well as filter options to select what types of events are shown. Once the filter is used and a date selected, the interface (521) displays a list of upcoming events in the app. The listed events are interface elements that may be operated to learn more about, or participate in, the displayed event. In an embodiment, the venue may use its dashboard to schedule events, which are then available for display to users via the users' apps (105). Users may then sign up to participate in the event via the app. When the user arrives at the venue, the system may cause only channels associated with that venue to be available for users to view or access. Other channels may be visually indicated as being unavailable, such as by greying out.

In an embodiment, the interface may implement features and functions that include at least, and without limitation, viewing and planning participation in karaoke events, viewing upcoming events, viewing past events, and browsing events by selected date.

In an embodiment, the user may select the venue (109) at which the user will participate in karaoke. This may be done by entering text in a search box in the GUI, selecting from a drop-down, searching a map interface, or geolocating the user via the device's (103) GPS or other geolocation technology to find or suggest nearby venues (109), or using other techniques now known in the art or in the future developed. Conceptually, this function is similar to the “checking in” feature common on social media platforms. In an embodiment, the app (105) may include such social networking features, allowing the user to “check in” to the venue (109), follow the venue (109), and provide/receive updates to/from the user's friends, followers, or other contacts within the app (105) and/or other social networks via integrations. Exemplary embodiments of interfaces (523) implementing these functions is shown in FIGS. 10, 23 and 24.

Once the user has selected the karaoke venue (109), the user will have access to various venue-specific features. These may include a “now playing” function which displays on the mobile app (105) the current user performing and/or song being played, and may give the user the option to view the lyrics on the app (105) in real-time with the performance. Due to network delays, this could result in a lag between the live performance and lyric display. To correct for this, the app (105) may enable the device (103) microphone to receive the ambient audio of the current live performance, and use AI techniques detect the current timestamp of the song being performed, and then synchronize the display of lyrics accordingly. In an embodiment, the user may instead use the built-in microphone(s) of the user's mobile phone as the performance microphone, which can reduce the risks associated with a shared public microphone used by multiple vocalists (e.g., illness, germs). The system may communicate with the karaoke station (111), which is managing song playback, and can quickly be queried to indicate where in the song the performance is. The “now playing” feature may also give the user the ability to learn who is performing by displaying that person's stage name and/or real name, avatar/profile pictures, see a history of songs performed, venues, favorites (songs, venues, artists, etc.), and other features common in social networking apps.

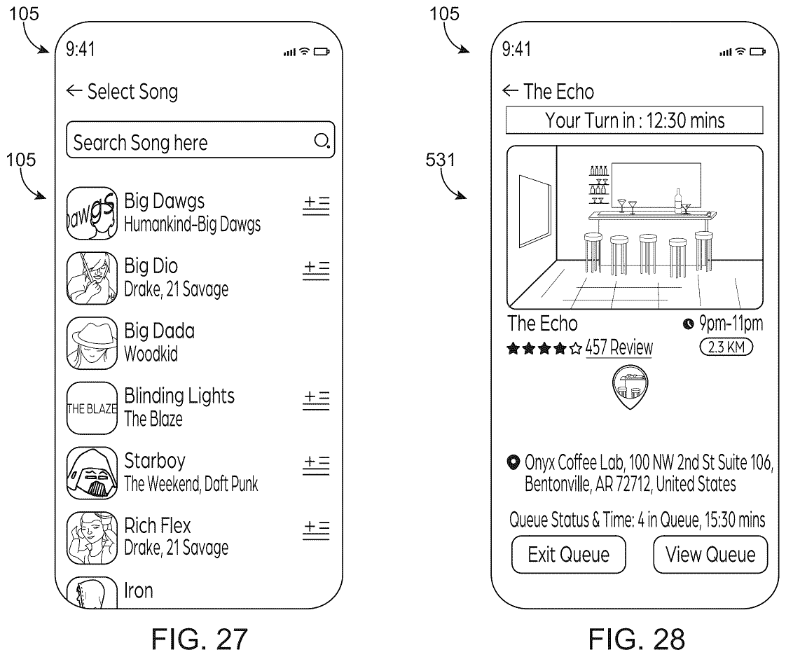

In an embodiment, the app (105) provides a music discovery or song search function. Non-limiting, exemplary embodiments (531) are depicted in FIGS. 11, 19, and 27. The user may manipulate the GUI of the app (105) to search for or browse songs available at the venue (109). This may be done using a free-form text search field, browsing a list, searching by criteria (e.g., artist, genre, year, decade, album, song length, range, solo or duet, etc.). The interface may facilitate viewing a list of popular songs for that venue, and filter options may be available to filter out songs that have been performed recently (e.g., within the last hour, two hours, four hours, etc.). The interface may provide access to features and functions that include one or more of, without limitation, browsing by genre, searching by title or artist, reviewing song details with metadata, and personalized song recommendations.

A venue (109) may have a venue administrative user, or VAU, who has special functions within his or her own version of the app (105) to manage these settings and filter and control what the users can search for. For example, the venue (109) may disallow a song to be performed more than once within a specific time period (e.g., 4 hours), which could cause that song to be “greyed out” or otherwise not selectable, possibly with a timer showing when it will next be available. Also by way of example, the VAU may be able to limit selections on a permanent and temporary basis. For example, if the venue (109) is doing an “80's night,” the VAU may configure the app so that the only songs available that day are those songs published in the 1980s. In an embodiment, the venue app is a web-based application that may be accessible via a tablet computer, the karaoke station (111), a mobile device, or another computer, upon authenticating that the user is has administrative privileges for the venue. Such authentication may use secure authentication techniques, such as multi-factor authentication.

Once the user locates a song available to perform, the user submits the selection and is added to a performance queue for the venue (109). Alternatively, the user may wish to perform at a specific time. For example, when the user first arrives, he or she may wish to first have a drink and/or eat, and does not wish to be queued immediately. In such cases, the app (105) may provide the ability for the user to specify a time range when the user can perform. Again, the availability of these options may be venue-specific, and managed by a venue administrator user.

In an embodiment, the user may have several options of which track to select as the backing track. The user may be able to select a typical karaoke backing track that re-creates the instrumentals, but for some songs the user may be able to perform to the original master using a “stem.” The creation and use of stems are described elsewhere herein. If the user has a local stem or other backing track on his device (103), the user may be able to select that version. If that version is not already available via the station (111), the user may be able to transfer or upload it to add it to the station (111) library, on either a temporary or permanent basis, for use with her or her performance.

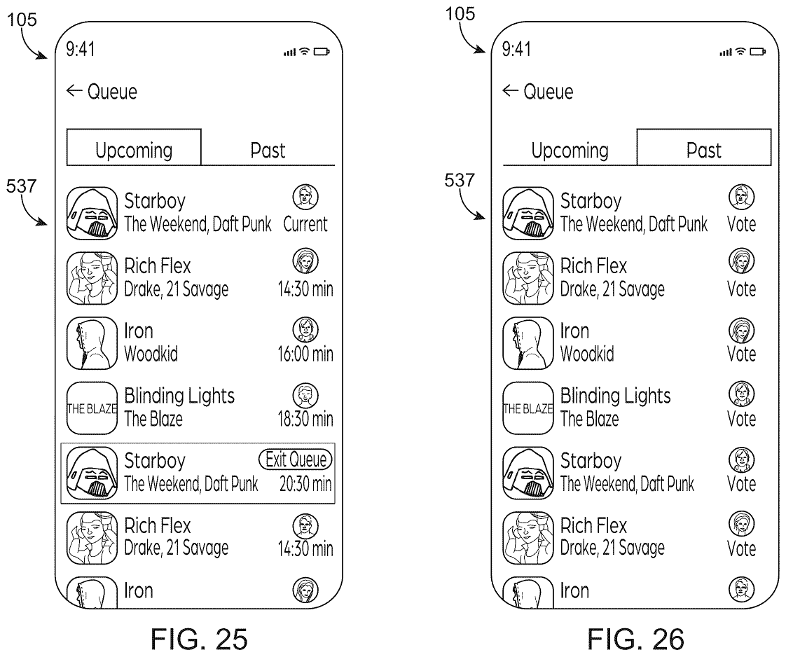

In an embodiment, once the user is queued or scheduled to perform, the app (105) may have a queue feature which shows the current schedule of upcoming performances, such as queued users and/or scheduled users and their time. The app (105) may also provide a timer or countdown for the user to keep easy track of the amount of time remaining before the user's performance. As the countdown approaches zero, the app (105) may provide notifications to the user, such as an audible tone, text message, app alert, vibration or buzz, or other technique for alerting the user. This helps ensure that users don't miss their performances and that the karaoke event runs smoothly. An embodiment (537) is shown in FIGS. 25-26, and 28.

In an embodiment, the interface may implement features and functions that include at least, and without limitation, informing users about events, engagement, and promotions (e.g., through real-time notifications), evening reminders, queue alerts, engagement notifications (e.g., likes, comments, interactions), promotional messages (e.g., from venues, artists, labels, or the platform), and local notification reminders (e.g., queue notices/“Time to Sing!”).

In an embodiment, the user selects which stem or stems they desire to accompany the user's performance as backing tracks. By way of example and not limitation, the user may wish to sing a song with only a piano and drums accompaniment, or piano and drums plus backing vocals from the original master recording. Once the user has paid the associated performance fee (if any), the song, and the selected stems, may be downloaded (e.g., from the a content management system or database), and then cached or otherwise stored on the station (111) in queue for playback at the appointed time for that user's performance. It should be noted that prior art karaoke typically permitted only a single instrumental track (e.g., a backing track recorded by a cover band or performer); the present systems, methods, and devices facilitate user-specific selection of which specific stems from an original master to use, which may comprise a single stem or a plurality of stems.

In an embodiment, the VAU may be able to manually edit the queue. This may be helpful in situations where the venue (109) desires a more curated experience, such as to ensure song variety, ensure a smooth and balanced flow of performances, avoid monotonous selections within similar genres, ensure good pacing and energy (i.e., avoid too many ballads played back-to-back), save crowd favorites for important moments, ensure performer variety, and for time and resource management for fairness and crowd control. Any such updates are then transmitted to the various app (105) users at the venue and their GUIs are updated, optionally with an alert, especially if the changes impact a user's estimated time to performance.

Once it is the user's term, he or she will be notified in advance to begin making his/he way to the stage to be ready. In an embodiment, the app (105) may provide a “warm up” feature where the user can hum or sing into the mobile device (105) microphone to warm up the vocal chords and/or tune, especially if the user has an audio feedback device (e.g., Apple™ Earpods) to user a makeshift monitor. The app (105) may prompt the user to warm up if necessary sufficiently in advance of the next performer.

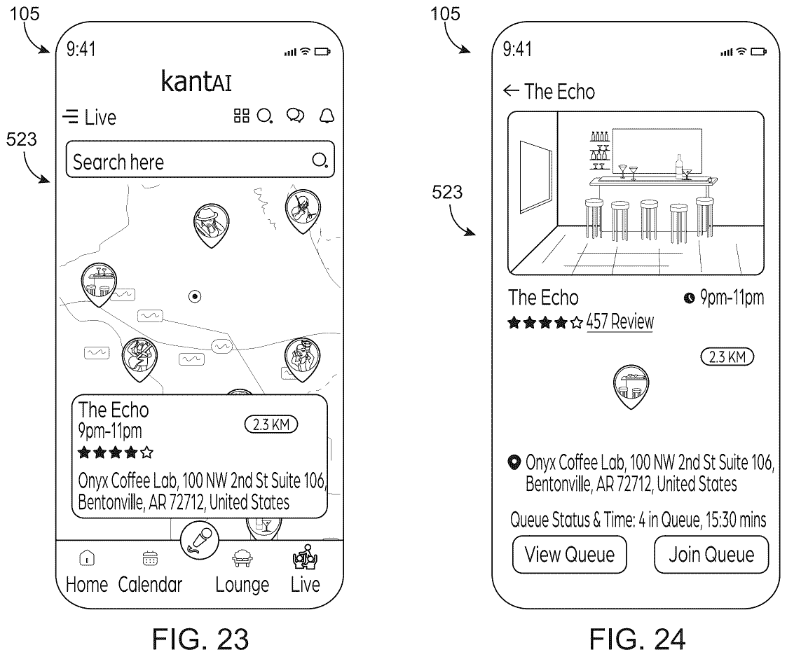

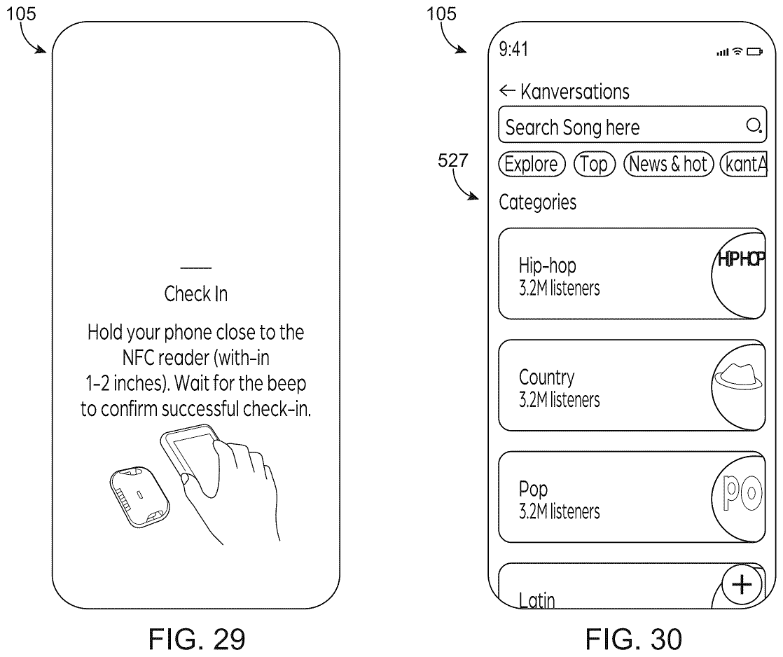

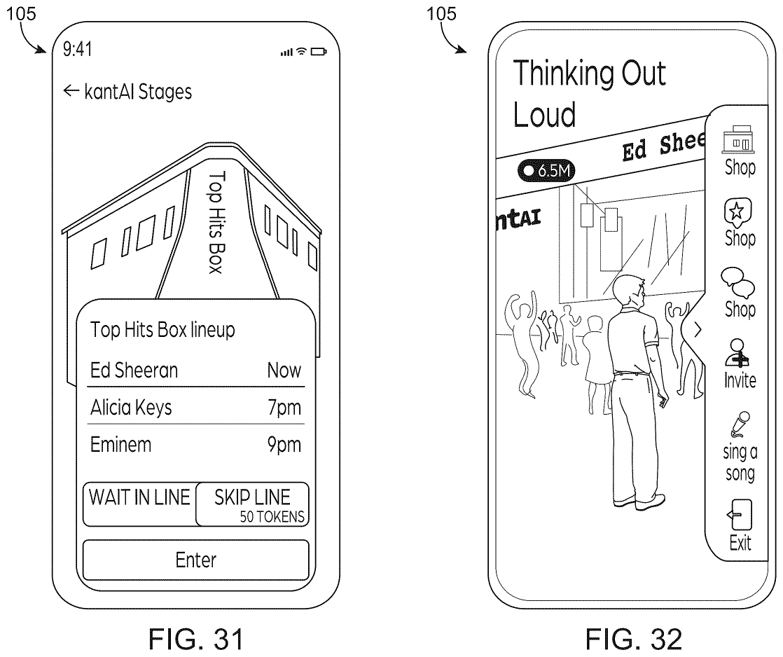

An aspect of the system is that users may our pay a fee to perform the song. Whether a fee must be paid may depend on various factors, such as which specific track is used and the licensing arrangements with the owner of that track. As discussed elsewhere herein, where the user chooses to perform to a backing track derived from the master recording, this fee will generally be required. This may be done automatically by charging the payment card on file in the user profile, or approving payment at the time of song selection using a built-in payment method, such as Apple™ Pay. Generally, the user is not charged until the song is performed (or is refunded if the user does not get to perform to any reason). Exemplary embodiments are shown in FIGS. 23-29.

In an embodiment, the app (105) may record the user's performance for later playback, such as by receiving the audio in real-time from the venue (109) microphone, or receiving a copy of the performance after it is completed. The user may also practice a song using the recording control (505). In an embodiment, the venue (109) may be outfitted with video capture equipment that also captures visuals of the performance, which may also be made available to the user for later playback. In some embodiments, these may be paid extras. For example, the user may be able to preview a low-resolution or low-quality version and, if he or she likes the performance, pay a fee to purchase the entire high-resolution, high-quality performance. Other social networking features may be available, such as sharing performances, tagging others in performances, and so forth. Exemplary embodiments of interfaces for recording are shown in FIGS. 11-18.

In an embodiment, the interface may implement features and functions that include at least, and without limitation, recording karaoke performances and practice sessions using audio and video tools, live audio recording (optionally with sound filters), live video recording (e.g., using user device camera), instrument toggle (i.e., on/off backing tracks), predefined audio effects (e.g., autotune, reverb), practice session history (e.g., play, save, delete), editing (e.g., trim), and performance score.

In an embodiment, the interface may implement features and functions that include at least, and without limitation, venue interaction and/or live participation, venue locator (e.g., map view), joining karaoke queue at selected venue, sharing a playlist or song request with the venue, viewing venue coupons, redeeming venue coupons (e.g., via QR code or paper), vote for performers (e.g., via QR code, in-app button, etc.).

In an embodiment, social experience features and functions may include sharing performances and engaging with other performers, a social feed displaying user performance posts, uploading performance videos, upvoting behaviors (like, comment, and share posts), viewing performer profiles, reporting inappropriate or abusive content, and filtering.

In an embodiment, the app (105) may also display advertising or marketing messages. These messages may be based in part on the venue (109), types of songs the user has performed or liked, and other user-specific preference information. For example, if the user is performing in Cleveland and singing classic rock songs, an advertisement or discount coupon for the Rock and Roll Hall of Fame may be offered. Likewise, labels and music publishers may supply advertising or marketing messages, such as upcoming concerts, pay-per-view events, and so forth. Venue-specific information may be provided or made available, such as hours of operation, food and drink menus, the ability to place orders and/or pay and/or tip. The app (105) may also provide performance-based incentives or rewards to encourage performance, such as the ability to give in-app tips to other performances, discounts at the venue (109) (or other venues) for performing, and so forth.

In an embodiment, the interface may implement features and functions that include at least, and without limitation viewing and redeeming coupons and rewards, redeeming performance tokens, and printing coupons and/or coupon confirmation at the venue.

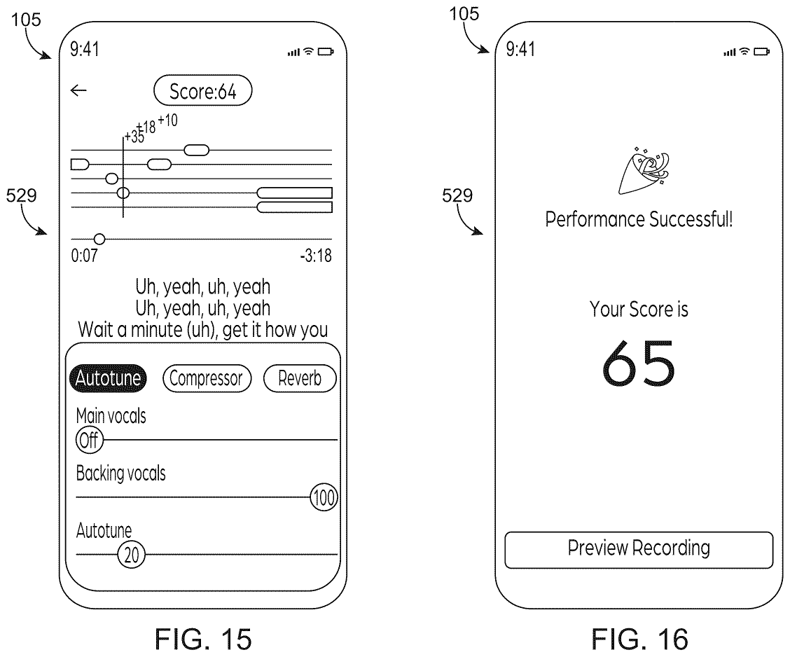

In an embodiment, the app (105) may be able to provide performance feedback to the user, possibly in real-time. For example, the app (105) may enable its microphone during the performance and provide a GUI for a virtual tuner, filtering for the user's voice and providing a GUI showing whether the user is sharp or flat, on pace or running behind or ahead. Exemplary embodiments are shown in FIGS. 15-18. Alternatively, the app (105) could serve as a metronome and provide vibrations or haptic feedback on tempo with the song. The user could thus leave his phone (103) in a pocket and keep tempo. The app (105) might also be able to isolate the user's vocal performance, which is typically sung into a karaoke microphone at the venue (109), and compare it to a reference performance or track to assess overall performance quality, and provide ratings or assessments of elements such as tempo, intonation, volume, and so forth. These ratings could be used to identify high quality performances and issue rewards, incentives, and/or other notoriety to talented or beloved karaoke singers. Performance ratings, whether or not shared with the user, may be used to make suggestions to users. This may be done by looking at common elements in the songs the user performs best and identifying other songs the user has not performed before that share those elements.

App (105) utilization data may be collected and provided to key stakeholders. For example, labels and music publishers may desire information about which artists and songs are performed the most, which may help identify trending artists, or artist that are uniquely popular in a specific region, which may help with scheduling live performances and making promotional decisions, including at the specific venue (109).

An aspect of the systems and methods that will have appeal to users is the ability to sing or practice with backing tracks outside of karaoke events. Many amateurs enjoy casual singing for personal pleasure with master recordings, but the user's perception of his or her performance can be distorted when singing in this fashion because vocal quality and pitch errors are often obscured by the recorded vocal track. The user will get better feedback, learn the lyrics better, and improve overall performance quality more quickly by performing to backing tracks. However, getting access to backing tracks is often not simple. Thus, an aspect of the system and methods is that the users can acquire stems of master recordings with the vocals removed to practice with in private, and use those exact same stems when performing at a venue (109).

Generally, the stems are created and managed using a separate set of software processes. Master recordings may be processed using various tools, including but not necessarily limited to artificial intelligence tools, to separate the vocal stems from the tracks and produce an instrumental-only backing track. Alternatively, such tools may be used to extract individual instrumental and/or vocal tracks from the master recording, known as “stems,” which may then be remixed without the vocal elements to create the backing track. Techniques for creating stems are known in the art. When the stems are selected by a user for a public performance at a venue (109), the system may have data or information about the associated parties who should be owed royalties (e.g., featured performers, session musicians, publishers, labels, etc.), and the associated royalty fee can be distributed. In an embodiment, the stems may also be separately made available to third parties for use in other contexts, such as through an on-line store or platform through which users could license stems for various uses. The stems may be fingerprinted (e.g., Pex, Audible Magic) for rights management and enforcement purposes. Stems may be utilized in other station (111) features or channels, such as a music trivia event where original master stems are played and the user has a limited amount of time to select the song which they belong to.

In an embodiment, music owners (i.e., record labels, artists) can participate in the ecosystem by registering an account with the stem creation site. They could then upload master recording files for processing and splitting into stems. In this fashion, music owners can develop new revenue streams for both new music and legacy music. Music engineers would then create the stems, generally using AI tools (e.g., LaLa.ai). The master files and stems may be associated with various industry metadata (e.g., artist, genre, title, album, tempo, key, year, decade, label, publisher, etc.). This information is all stored in a database associated with the stemming process, which may be a separate server computer system from that supporting operation of the karaoke stations (111) and apps (105). In an embodiment, stem reviewers may then review the produced stems for commercial viability, completeness, quality, and so forth. Once approved, the stem may be added to the stem store for license and use by consumers, such as artists, composers, songwriters, DJs, audio engineers, advertising and marketing agencies, the film and television industry, video game producers, music studios, and bulk or stock music licensing organizations and platforms. A “stem store” and/or API may be available to developers to develop stem-based apps and stem-based channels. The systems and methods also provide a new revenue stream for performing artists, who ordinarily do not receive performance royalties for live terrestrial performances, such as karaoke.

It should be noted that the processes described herein may apply to any use of the system in which stems are created or used. That is, a goal of the preferred embodiment is to minimize or reduce the storage of stems in persistent memory for an extended period of time (e.g., significantly longer than the period time for which stem data is required for operational use), and to minimize or reduce the extent to which stems are stored externally from point devices such as user mobile devices and/or stations (e.g., on servers, from which they are transmitted to point devices, raising the risk of misappropriation). Thus, as described elsewhere herein, stems may be isolated in advance of a performance (whether live in a venue, or for practica on a user device) and made available only for use during a performance, and only on the device or devices on which the data is necessary for the performance. The stems may then be deleted after the performance (e.g., immediately, on a timer, or purged on a schedule). The particular timing of this deletion may vary from embodiment to embodiment and from device to device (e.g., stems may be deleted promptly from user devices but purged nightly from karaoke stations).

Another aspect of the systems and methods is a “virtual karaoke” feature, which may be built into the user app (105) or may be a separate app (105). In an embodiment, this feature includes a “lounge” section, which provides various features for interactive engagement, such as chat/posting boards/conversations. In an embodiment, this feature may include special communication tools reserved for prestige users, such as featured artist and performers, who may be able to broadcast or directly send audio communications to other users who may be able to provide non-audio feedback (e.g., comments and text, similar to how livestreaming works on platforms like YouTube and Twitch). Exemplary embodiments (527) are shown in FIGS. 9 and 30.

In an embodiment, virtual karaoke includes “stages” feature to provide gamified virtual karaoke. In this feature, the app displays a rendering of a venue that includes a stage, which could be based on a real-world venues (109) or which maybe an entirely fictional venue. The real-world venues (109) could be famous venues (109) or could be smaller, local venues (109), such as a karaoke venue (109). Generally, the venue (109) will be a venue having a karaoke station (111) according to the present disclosure. Exemplary embodiments are shown in FIG. 9, and 31-32.

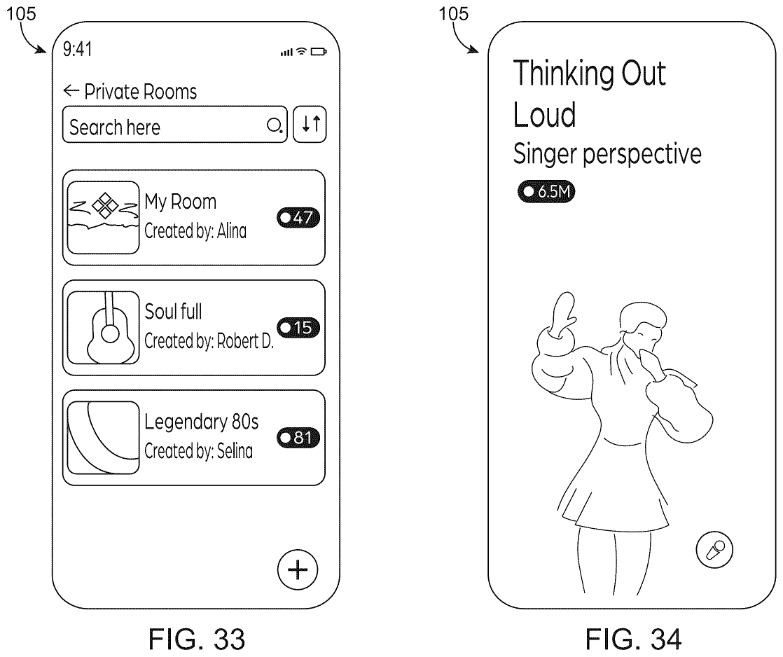

The GUI allows users to “attend” a performance at the virtual stage and to navigate and explore some of all of the environment by manipulating the GUI, similar how avatars move in video games. The environment may be two-dimensional or three-dimensional, or may be a hybrid (e.g., a three-dimensional environment using two-dimensional avatar sprites). In an embodiment, this feature could be implemented via a virtual reality or augmented reality device, such as a headset or googles, which may provide a more immersive experience. However, this is not necessarily required. At any given time, a karaoke performance may or may not be taking place at a virtual venue, and other users who “attend” or join that venue can observe the performance via the app (105). The GUI may provide various options for users in the audience to interact with the performer, such as by rating the performance, providing remarks/comments, “following” the performer or the song (to see other performances of favorite songs), tip/donate, and other features commonly found in social networking. Exemplary embodiments are shown in FIGS. 33-34.

The user may also choose to perform. This would function very similarly to the live karaoke app (105), in that the user would select the song/track to perform, be added to the queue, and receive notifications when it is almost time for that user to perform. Once the user is ready, the user listens to the backing track in his or her personal device (e.g., headphones, Earbuds, etc.) and performs into his or her mobile device (103). Due to network latency, the server computer supporting these services will analyze and synchronize the backing track and the audio feed received from the performer, and broadcast that synchronized performance to the audience in the virtual room. Exemplary embodiments are shown in FIGS. 33-34.

The system may also offer the ability to purchase virtual goods and assets, and may have achievement systems to unlock special perks and benefits. These may include, but are not necessarily limited to, badges, achievements, special avatars, accessories for avatars, unlocking access to premium tracks and songs, skipping the queue, premium skins, branded visual assets (e.g., badges associated with a user's favorite artists, performers, venues, etc.), and so forth. Users may also have the ability to order real-world goods, such as artist apparel, tour-specific merchandize, physical or digital music purchases, concert tickets, and so forth. In an embodiment, certain perks may be available only through the virtual karaoke system, such as early access to reserved seating at concerts, limited release versions of albums, and so forth.

In an embodiment, a virtual venue has a type of virtual persistence. That is, only one performer (or a discrete, finite number of performers) is allowed to perform at a given virtual venue at a time, and all audience members viewing that stage see that performance. This differs from streaming, as streaming platforms like YouTube and Twitch allow each streamer to create his or her own channel. Here, the venue is effectively a static channel that may belong to nobody, and anybody can temporarily be the featured performer on that channel by queuing.

In an embodiment, a venue may be curated. This means that an administrative user with elevated privileges and access to non-public features has control over who performs and when, similar to a venue administrator in real-life karaoke. For example, a music label might choose to sponsor a virtual venue/stage and limit performances to songs managed by that label.

In a further embodiment, personal stages may be implemented, which function more like traditional streaming in that an individual user controls and manages the virtual venue, curates the content, and may have invite-only venues or invite-only sessions in which private performances are done. This might be used by featured artists who can sell access or tickets to these private performance, preview upcoming new songs, and give selected audiences a more intimate, personal performance experience in a virtual environment, avoiding the risk, hassle, cost, and inefficiency of such performances in real-world venues. Exemplary embodiments are shown in FIGS. 33-34.

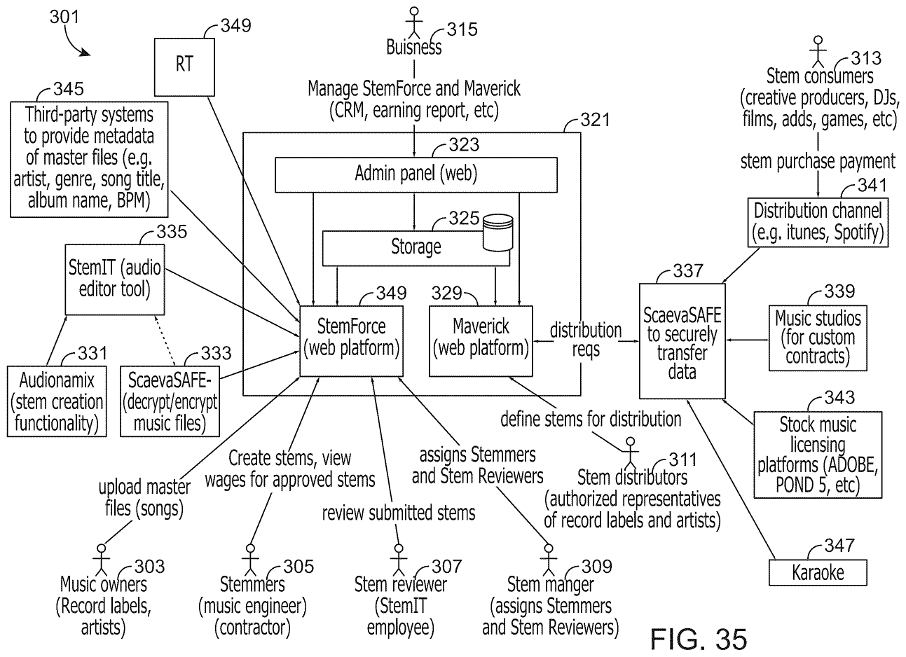

FIG. 35 depicts an embodiment of systems, methods, and apparatuses for enhanced karaoke according to the present disclosure. In the depicted embodiment of FIG. 35, the relationship of various participants in the karaoke ecosystem is shown, including music owners (303), music engineers (305), reviewers (307), managers (309), an administrative/technology business (315), distributors (311), and consumers (313). Each of these individuals and/or organizations plays a role in transforming raw, original master recording recordings of music into usable stems, properly archived and tagged with metadata in an on-line platform and store for use in karaoke and other purposes.

In the depicted embodiment, this is done using a computer system (321), generally a server and/or collection of servers (321) connected to a telecommunications network, such as the Internet, to provide remote service access to various functions and on-line services provided or made available at the server (321) over the network. The depicted computer server (321) comprises one or more computers programmed with application software, configured to support and coordinate the functions described herein. The depicted server (321) includes modules and subsystems for various tasks shown and described herein, as well as other routine and ordinary functions of server computer systems, such as user authentication, data storage and retrieval, queue management, content delivery, communications, and analytics. A server computer (321) is communicably coupled to a telecommunications network and exchanges data with multiple other system components, including user devices, client systems, karaoke stations, administrative systems, and third-party services. The depicted server (321) receives requests and commands from client applications, processes those requests in real time or near-real time, and transmits corresponding responses, data, or instructions back to the requesting systems. In some embodiments, the computer server (321) further communicates with external databases, content management platforms, or payment processors to facilitate functions such as song licensing, stem retrieval, royalty calculation, or financial transactions. The architecture may include load-balancing, failover, and redundancy measures to ensure high availability and reliability.

The depicted server (321) has a plurality of hardware and/or software modules, including an administrative panel (323), and various web platforms (327) and (329) that provide different services. In the depicted embodiment, a first web platform (327) provides stem creation services and a second web platform (329) provides e-commerce services for stems, such as storage, management, distribution, tracking, licensing, and the like. The depicted server (321) also comprises a data store (325), such as a database, for the storage and retrieval of data and files.

In the depicted embodiment, the process begins with music owners (303) providing master recordings to the server (321) via a transfer mechanism. This could be physical delivery, but digital upload is more likely and convenient. A web platform module (327) receives and processes these songs, generally storing them in a secure, encrypted location (e.g., the data store (325)), due to the economic value of the originals. Next, stems are extracted from the original master recordings. This may be done using a stem creation system (331), which may be on or part of the server (321) or which may be a third party service (331), as shown in FIG. 35.

In the depicted embodiment, the master files are transferred via a secure/encrypted file transfer mechanism (333), and may be modified or edited using an audio editing tool (335). The resulting stems are transferred back to the server (321) for processing and storage in the data store (325). The songs and/or stems may be tagged with metadata, containing information such as artist, genre, song title, album name, tempo, and other common music/track metadata. This information may be retrieved from the data store (325) and associated with the masters and/or stems, or may be received from an external third party data source (345) and stored in the data store (325) in association with the masters and/or stems.

These processes and steps may be conducted, in whole or in part, by one or more music engineers (305), reviewers (307), and managers (309), who can ensure stem quality and usability and confirm the accuracy and completeness of metadata. In the depicted embodiment, these users (305), (307), and (309) and systems generally interact over the server (321) via the first web platform (327), which is focused on stem creation and which communicates with the data store (325).

Once created, the stems may be made available for commercialization and use via a second web platform (329), which may provide various e-commerce services. The second web platform (329) also communicates with the data store (325) and can conduct database operations concerning the stems and their associated metadata, such as retriever and search. When users request stems for commercialization opportunities, the stems may be securely transferred via a secure transfer mechanism (337) and then made available as needed for the particular commercialization opportunity. By way of example and not limitation, stems may be licensed to stock music licensing platforms (343), used by music studios (339), or distributed to end-consumers (313) via distribution channels (341) such as Spotify or iTunes for personal use. The stems may also be available for karaoke (347), such as by providing access to stem playback for practice via a user app or providing the stems for backing tracks during karaoke performances via a karaoke station, as described elsewhere herein.

In the depicted embodiment, the server (321) and resulting stem files are generally in the custody and control of an administrator (315), who will manage and oversee the use of the server (321), typically via a remote administration module or panel (323) in a manner familiar to those skilled in the art.

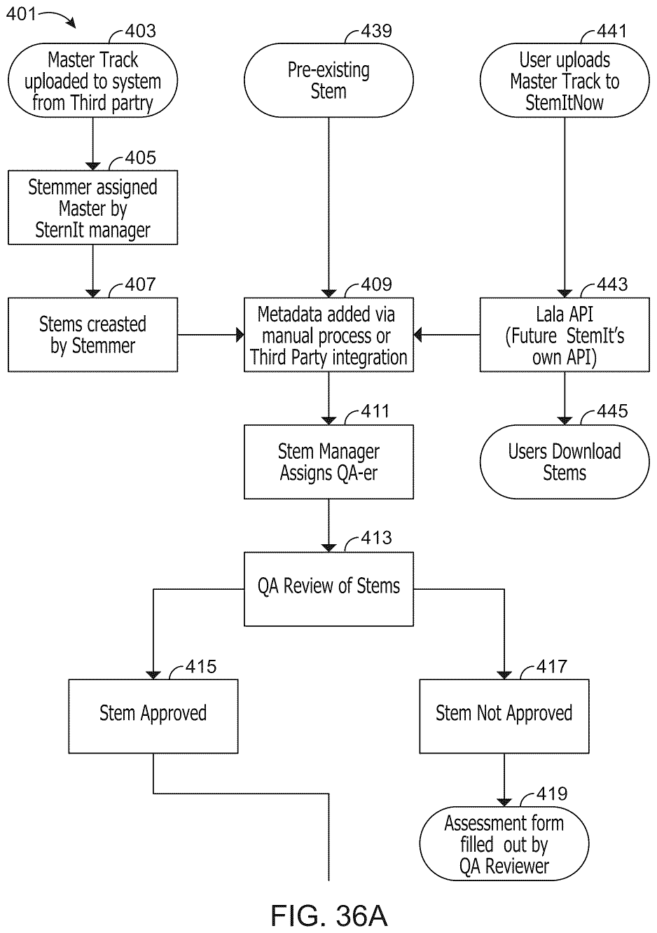

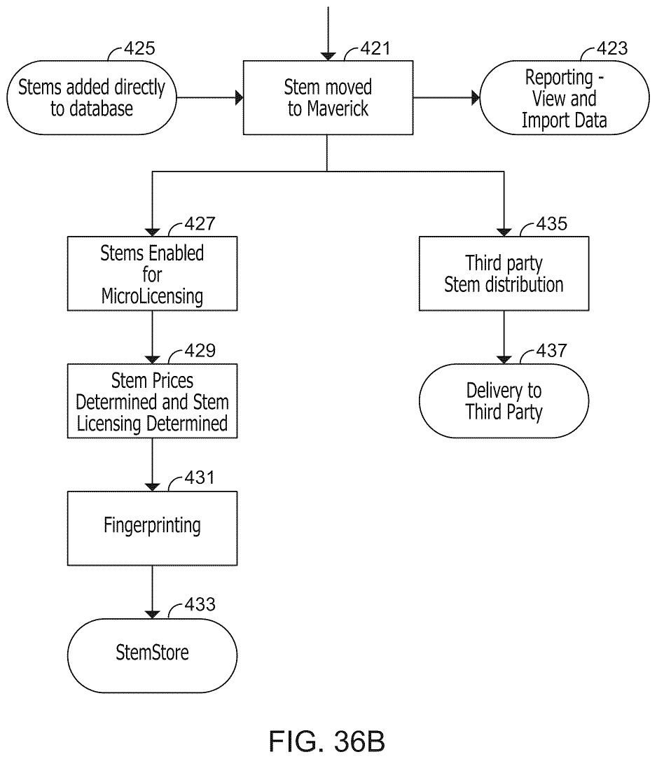

FIGS. 36A and 36B depict a flow chart showing an embodiment (401) of how stems may be created and managed using a platform architecture such as (but not limited to) that depicted in FIG. 35. In the depicted embodiment, master tracks are uploaded or otherwise transferred (403) to the server and a music engineer is assigned (405) to conduct the stemming process, typically by a manager user. The music engineer facilitates the stem creation process (407) as described elsewhere herein, and metadata for the stem is added (409), either by manual process, local database, or third party data sources.

A reviewer is then assigned (411) to conduct quality-assurance (413). If the stem is not approved (417), the reviewer takes appropriate stems to reject the stem (419), and the process may restart or return the stem to the music engineer to re-stem (407). If the stem is approved (415), it is stored in the data store (425) and reporting information may be generated (423). The stem is then also available for commercialization (421) (e.g., via the second platform of FIG. 35).

The stem may then be licensed and retrieved in accordance with the business rules of the platforms and permissions granted by the music owners, such as for microlicensing (427) or other distribution (435). In the latter case, the stem is delivered to a third-party customer or user (437). For microlicensing, pricing and terms must be determined and set (429), and the stems may be fingerprinted (431) for security and digital rights management before the stem is placed into an e-commerce platform or “stem store” for licensing (433).

In some cases, stems may already exist (439). In such circumstances, the music engineer step can be skipped and the stem can be populated or associated with metadata (409) and then sent to a QA reviewer (411), and the process continues as described. As noted above, the stemming process may be internal, such as shown in steps (441), (443), and (445), where users upload masters and they are stemmed in-house and made available, rather than being stemmed through a third-party source.

The depicted embodiments describe systems (301) and methods (401) in which stems are derived from master files in advance of use, but in an alternative embodiment, stems may be generated on-demand in real-time or near-real-time in response to user requests. This may be done using software systems at the server (321) or via a third-party real-time stemming service (349), such as music.ai. In either case, the user experience is generally the same, and the choice of whether to pre-stem or stem on-demand may be invisible to end-users of stems. This solution may be preferrable to avoid the risks associated with creating and storing stems in a centralized repository, where they could be compromised, leaked, or lost. This also eliminates substantial processing time and resources producing stems that may never be needed or used, and thus have no economic or commercial value. In such an embodiment, when a stem is needed, the specific stem and original track is requested, and the requested stem is then produce on-demand and in real-time or near-real-time, and then sent to the user for the requested use. In an embodiment, upon the conclusion of the use, the stem may then be deleted from both the end-user device or client system and/or the data store. In some embodiments, the stem may never be stored at all, other than in ephemeral memories.

A downside to this approach is that commonly-request stems may need to be repeatedly produced, re-introducing the potential waste of processing power to continually re-create stems on-demand that has previously been stemmed. One possible solution to this problem is to keep track of stem request statistics and trends to identify frequently-requested stems, and to temporarily or permanently retain copies of frequently-requested stems to reduce processing usage, while also not having to maintain a vast library of stems, most of which may never be used. In such an embodiment, the stems may be retained temporarily for a period of time based on detected usage and demand trends. In a further embodiment, which stems to cache, and how long to cache them for, may be based on external data and other factors. By way of example and not limitation, if a performing artist is on tour, his/her most popular songs may be more frequently requested, and thus stems for those songs may be cached for the duration of the tour, or for another period of time (e.g., through the weekends). The particular schedule and factors used to determine cache retention may vary from embodiment to embodiment. In some embodiments, a mix of pre-stemming and on-demand stemming may be used.

The depicted systems and methods of FIGS. 35, 36A, and 36B are exemplary only and other systems and methods are possible. For example, the two web platforms may be combined into a single platform, or may be further functionally segregated. Likewise, the allocation of tasks between the two (or one, or more) platforms may differ from that depicted. Generally, it will be preferable to functionally isolate stem-generation from stem-consumption, but this may not always be the case, particularly (but not necessarily limited to) in a real-time, on-demand environment.

In an embodiment, the system imposes an authentication gate before access is granted to any content. In an embodiment, access may be limited to one active session per registered user account, and multi-factor authentication may be required. In an embodiment, authentication may be performed on a per-device basis, and/or may be limited by device (e.g., a maximum number of authorized devices, or a maximum number of concurrently authorized devices). In any embodiment, some or all content on a device may be automatically deleted when the device is disassociated or de-authorized. In an embodiment, the system implements group or family plan logic (e.g., linking accounts, shared payment method, membership restrictions, family-only enforcement). In an embodiment, authentication is billing-based (e.g., through payment method metadata). In an embodiment, authentication is geographically limited.

In an embodiment, the access to streamed or generated content is provided on the basis of ephemeral, temporary, or single-use resource access identifiers (e.g., URLs). In an embodiment, such access is temporally limited (e.g., the identifier automatically expired or is rendered inoperable after a defined amount of time has lapsed). In an embodiment, the identifiers are local-only and/or otherwise inaccessible outside the application or system. In an embodiment, content is delivered in an encrypted format (e.g., AES-128). In an embodiment, the system comprises a playback system which inhibits permanent storage, ripping, or other copying or transfer of content to another device or physical medium. In an embodiment, the system comprises digital rights management (e.g., HDMI copyright flags). In an embodiment, the system detects technical measures that signal potential security risk to content (e.g., VPNs, use of open proxies, etc.) and may implement techniques for limiting or blocking access to or use of same. In an embodiment, the system adopts and enforces a single-stream-per-user rule. In an embodiment, the system comprises a content-entitlement engine. In an embodiment, stem separation is performed in real-time only, on-device, without persistent storage. In an embodiment, the system comprises anti-fraud systems and methods, such as, but not necessarily limited to detecting automated clicks and/or bots, fake plays, fake impressions, fraudulent SEO/referral behavior, excluding fraudulent events from royalties and monetization, and/or algorithmic fraud detection, anomaly scoring, and pattern detection.

In an embodiment, the system comprises a karaoke station (111) as well as a supporting audiovisual system (601). In such an embodiment, the supporting audiovisual system provides a central point of connection and communication between the karaoke station (111) and venue-specific equipment such as microphones, televisions, displays, and venue speakers and other audio-visual equipment. This may be done directly or, more likely, by connecting the supporting audiovisual system (601) to a venue controller, receiver, or other venue audiovisual management system. This architecture is preferred, as it allows for a layer of hardware separation between third-party equipment that is owned or leased by the venue, and establishes a uniform hardware and software interface to the karaoke station (111). This helps to ensure that, regardless of a venue's specific audiovisual hardware, software, or configuration, the karaoke station (111) can be used with at least partial functionality and, often, full functionality.

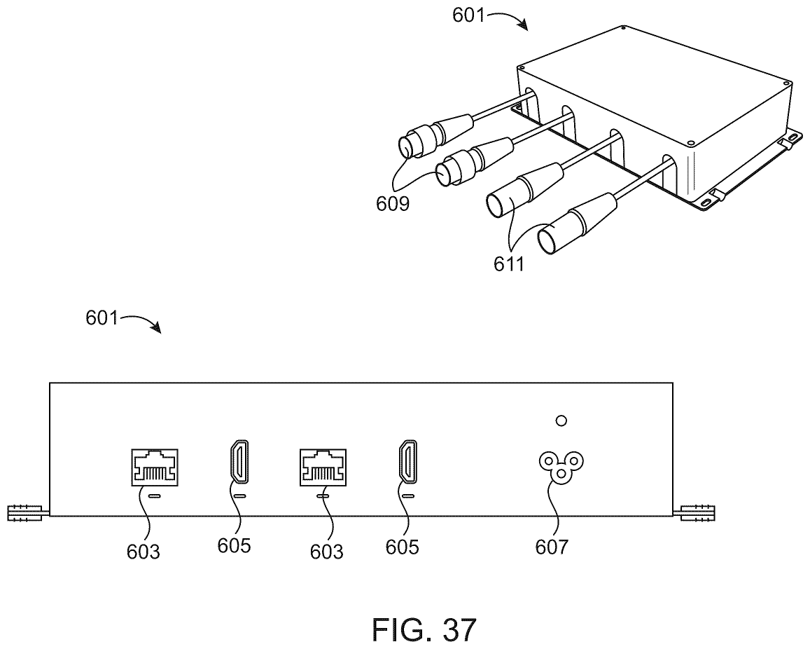

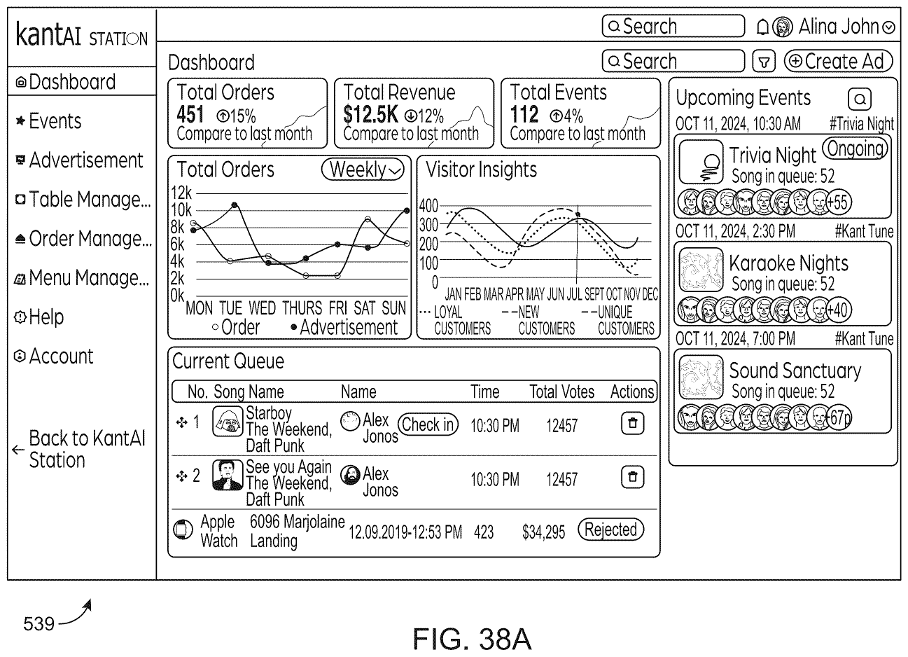

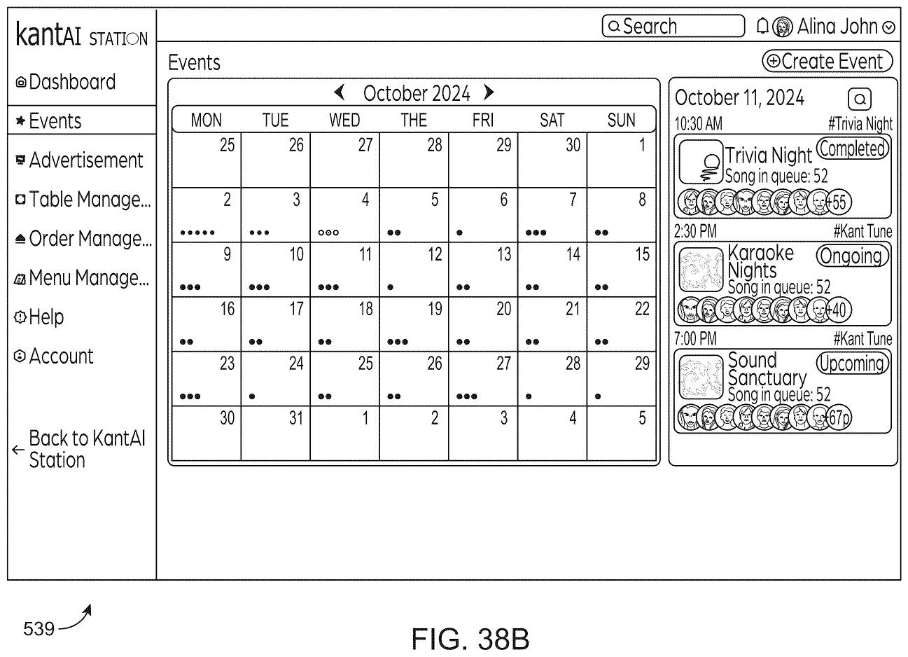

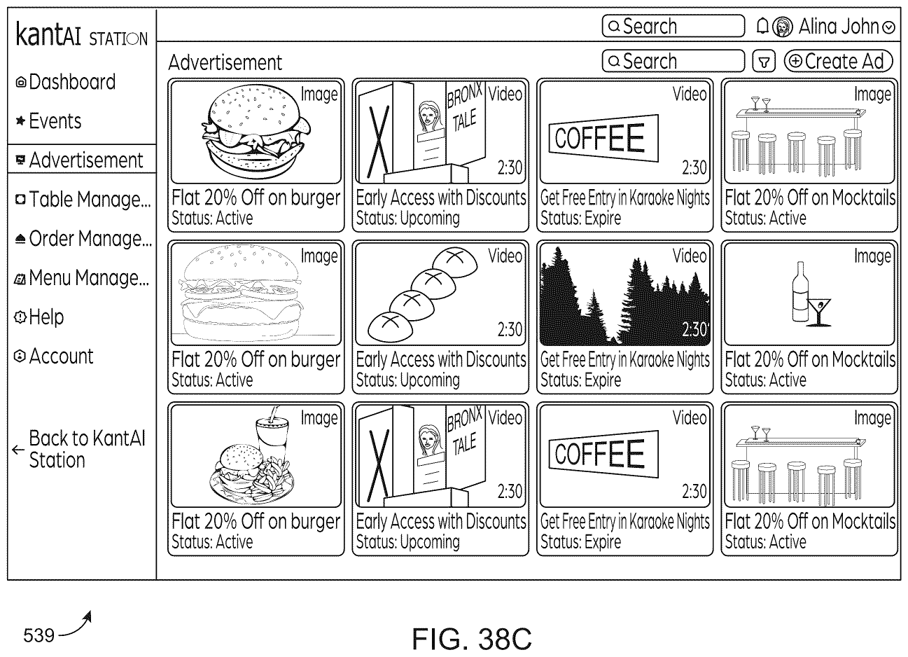

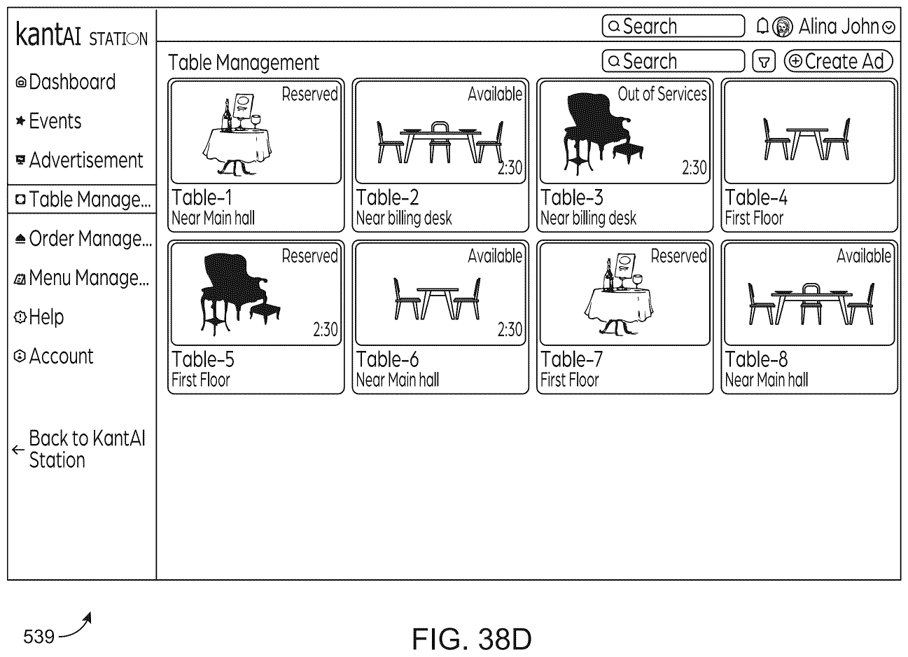

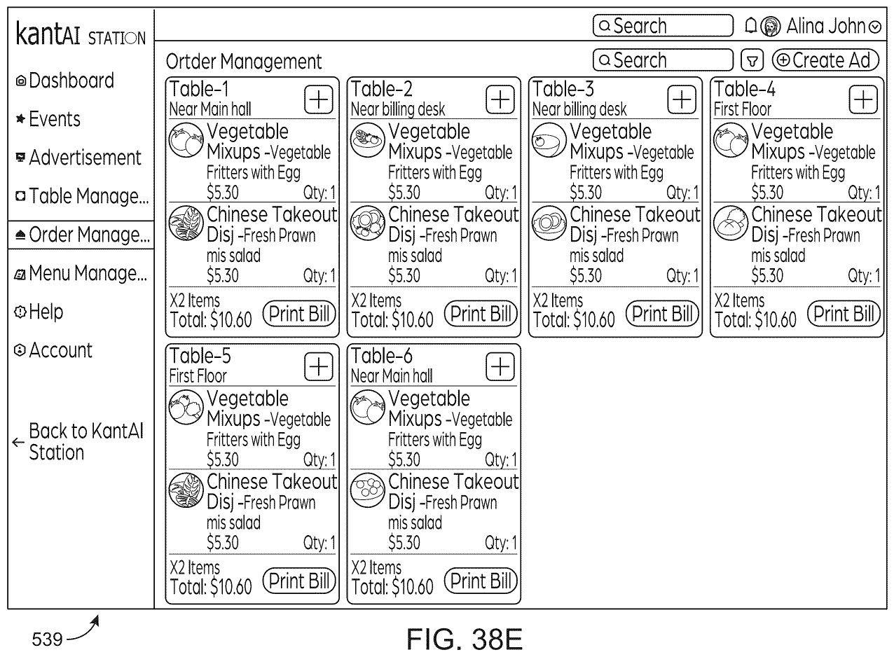

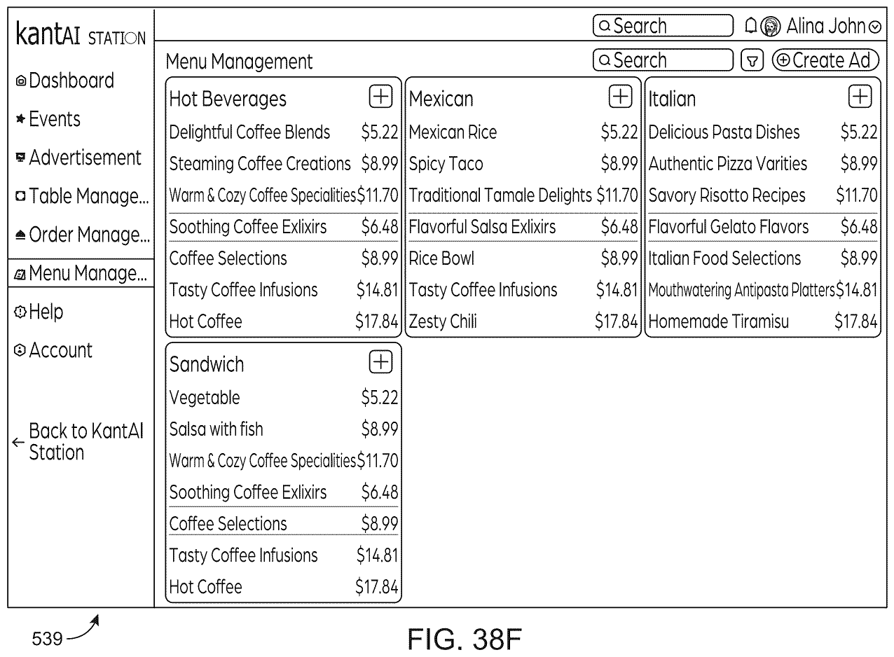

The supporting audiovisual system (601) thus may comprise one or more audio and/or video inputs or outputs, and may also comprise one or more wired or wireless communications ports. By way of example and not limitation, an embodiment may comprise an ethernet port and connections for at least one microphone (e.g., XLR) and at least one audio-visual wire (e.g., HDMI). This system (601) may be responsible for streaming audio and video to venue audiovisual equipment, and may also stream audio performances back to the karaoke station (111). In an embodiment, the supporting system (601) handles one or more tasks described herein, which may include, but is not necessarily limited to, separating stems, streaming content, streaming promotional or marketing materials, serving an administrative panel or dash board, retrieving content, managing the queue, and so forth. In such embodiments, high-processing workloads and tasks may be shifted from the karaoke station (111) to the supporting system (601). This allows the karaoke station (111) to be a more purpose-built device for direct user interface, with focus on the end-user experience. A non-limiting exemplary embodiment is shown in FIG. 37, which depicts a supporting system (601) comprising a plurality of network ports (603), a plurality of audiovisual ports (605), at least one power supply port (607), a plurality of audio input ports (609), and a plurality of audio and/or audiovisual outputs (611) to connect to the venue AV system. FIGS. 38A-F depict an embodiment of a station dashboard according to the present disclosure.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer-or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally co-temporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

Throughout this disclosure, the term “embedded system,” “embedded computer,” and variants thereof distinguish special purpose computer hardware and software from general-purpose computer hardware and software. As used herein, an embedded system is a special-purpose system in which the computer is mostly or completely encapsulated by the device it controls. Unlike a general-purpose computer, such as a personal computer, an embedded system generally performs more limited, pre-defined tasks, usually with very specific requirements to accomplish a limited and pre-defined set of operational tasks. Since the system is dedicated to a specific task, it is more easily optimized for the task, reducing size and cost by eliminating unnecessary components found in general-purpose computers, and designing board circuitry and system geometry to improve operational efficiency, reduce manufacturing cost, and address operation-specific conditions, such as temperature extremes. The karaoke stations may be or use embedded systems.

For purposes of this disclosure, there will also be significant discussion of a special type of computer referred to as a “mobile device” or “user device.” A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a user's person, and usually is in near-constant real-time communication with a network.

Throughout this disclosure, the use of the conjunctive and disjunctive should not necessarily be construed as limiting, and the conjunctive may include the disjunctive, and vice versa.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A karaoke system comprising:
a computer server communicably coupled to a telecommunications network and providing via said telecommunications network, in response to user requests, one or more original master recording stems created by extracting one or more individual instrumental and/or vocal tracks from original master recordings;
a karaoke station disposed in a karaoke venue, said karaoke station communicably coupled to said telecommunications network;
a user device associated with a user, said user device comprising a processor, a microphone, an imaging system, and being communicably coupled to said telecommunications network;
a computer server communicably coupled to said telecommunications network;
wherein said computer server provides karaoke services to said karaoke station and said mobile devices via said telecommunication network.

2. The karaoke system of claim 1, wherein said user installs a karaoke application on said user device.

3. (canceled)

4. The karaoke system of claim 2, wherein said user configures said karaoke application with a user profile for said user, said user profile comprising one or more of: a phone number, an e-mail address, a zip code or other geographic locator, payment card information or payment system information, a user photo, a user avatar, a user stage name or handle.

5. The karaoke system of claim 4, wherein said karaoke station comprises an outer shell, a display, and a user interface.

6. (canceled)

7. (canceled)

8. The karaoke system of claim 5, wherein said karaoke station comprises a central processing unit, a non-transitory machine-readable memory, a non-transitory machine-readable storage, network communication equipment, and one or more external interfaces; wherein said one or more external interfaces comprises interfaces configured for audio, visual, or audiovisual electronic communication.

9. (canceled)

10. The karaoke system of claim 5, wherein said karaoke station further comprises a video and audio capture system configured to record audio and visual elements of a karaoke performance wherein said recording is accessible for replay in said application.

11. (canceled)

12. (canceled)

13. The karaoke system of claim 2, wherein said karaoke application provides a plurality of functions to said user.

14. The karaoke system of claim 13, wherein said plurality of functions is provided via a graphical user interface; wherein said graphical user interface includes a plurality of interface controls for accessing other functions in said plurality of functions.

15. (canceled)

16. The karaoke system of claim 14, wherein said plurality of functions comprise one or more of the functions selected from the group consisting of: calendar, lounge, live, ordering food and beverages, channels, recording, search, chat, alerts and/or notifications, profile setup, venue, virtual karaoke, providing performance feedback to said user, and an interface for practicing a song performance.

17. (canceled)

18. (canceled)

19. The karaoke system of claim 16, wherein said calendar function comprises a calendar interface comprising interface elements and/or controls for choosing a date, filtering results, displaying events and/or event details, scheduling events, and signing up for events.

20. (canceled)

21. The karaoke system of claim 16, wherein said user manipulates said interface to check in at said venue; wherein after said check in, said user receives access to functions. features, events, channels, and options associated with said venue.

22. (canceled)

23. The karaoke system of claim 21, wherein one of said functions is a now playing function which displays on said user device an identification of a user currently performing, and/or a song currently being performed, at said venue.

24. The karaoke system of claim 21, wherein one of said functions is adding said user to a performance queue for said venue by searching for and selecting a song for said user to perform at said venue and/or one or more of said original master recording stems provided by said computer server for said user performance.

25. The karaoke system of claim 24, wherein said system provides said one or more original master recording stems via said telecommunications network and, when said user reaches the front of said performance queue, plays said one or more original master recording stems on an audio system of said venue;
wherein while said system plays said one or more original master, said user performs said song using said microphone of said user device and lyrics for said song are displayed on a display of said user device in synchronization with playing said one or more original master recording stems.

26. (canceled)

27. (canceled)

28. (canceled)

29. (canceled)

30. The karaoke system of claim 24, wherein said system comprises venue administration application software configured for managing said karaoke system at said venue.

31. (canceled)

32. (canceled)

33. (canceled)

34. (canceled)

35. (canceled)

36. (canceled)

37. (canceled)

38. (canceled)

39. (canceled)

40. The karaoke system of claim 16, wherein said virtual karaoke feature comprises a virtual lounge interface providing interactive engagement with other users.

41. The karaoke system of claim 16, wherein said virtual karaoke feature comprises virtual stages having features comprising one or more of a rendering of a venue stage, a representation of other users viewing said virtual stage, a live performance by another user at said venue stage, and one-directional and/or interactive engagement with said performing user.

42. (canceled)

43. (canceled)

44. The karaoke system of claim 1, wherein said computer server is communicably coupled to a data store, said data store comprising a database of original master recording stems created by extracting individual instrumental and/or vocal tracks from original master recordings, and said providing via said telecommunications network, in response to user requests, one or more original master recording stems created by extracting one or more individual instrumental and/or vocal tracks from original master recordings comprises retrieving a requested original master recording stem from said data store.

45. The karaoke system of claim 1, wherein said wherein computer server comprises or is communicably coupled to a real-time, on-demand stemming module or service, and said providing via said telecommunications network, in response to user requests, one or more original master recording stems created by extracting one or more individual instrumental and/or vocal tracks from original master recordings comprises creating a requested original master recording stem in real-time, on-demand via said stemming module or service.

46. (canceled)

47. The karaoke system of claim 46, wherein said user request comprises an indication of an original master recoding from which said original master recording stem is requested; wherein said user may select one or more instruments to be included in said requested original master recording stem.

48. (canceled)
